(19) United States
(12) Patent Application Publication
(10) Pub. No.: US 2012/0254524 A1
(43) Pub. Date: Oct. 4, 2012

(54) MEMORY DEVICE AND HOST DEVICE

(76) Inventor: Akihisa FUJIMOTO, Yamato-shi (JP)

(21) Appl. No.: 13/524,835

(22) Filed: Jun. 15, 2012

Related U.S. Application Data
(63) Continuation of application No. PCT/JP2011/052189, filed on Jan. 27, 2011.

(30) Foreign Application Priority Data
Jan. 27, 2010 (JP) 2010-015950
Aug. 23, 2010 (JP) 2010-186481

(51) Int. Cl. G06F 12/00

(52) U.S. Cl. 711/103; 711/E12.008

(57) ABSTRACT

A controller has a random write mode and a sequential write mode to which it transitions when receiving a start command. The controller in the sequential write mode identifies a data stream partially formed by a data item through a control command or a logical address. It also prepares free unit areas for respective data streams, and writes data items in successive storage areas in a corresponding unit area in an order identical to addresses of the data items. When the controller receives an end command, it performs end processing on a unit area for a corresponding data stream. The controller in the sequential write mode transitions to the random write mode when completing the end processing to all data streams or detects a random write request.

### CROSS REFERENCE TO RELATED APPLICATIONS

This application is a Continuation Application of PCT Application No. PCT/JP2011/052189, filed Jan. 27, 2011 and based upon and claiming the benefit of priority from prior Japanese Patent Applications No. 2010-015950, filed Jan. 27, 2010; and No. 2010-186481, filed Aug. 23, 2010, the entire contents of all of which are incorporated herein by reference.

### FIELD

Embodiments described herein relate generally to a memory device and a host device.

### BACKGROUND

A memory device in which a nonvolatile semiconductor memory such as a flash memory is utilized is currently used as a recording medium for music data and video data.

### BRIEF DESCRIPTION OF THE DRAWINGS

FIG. 1 illustrates functional blocks of a host device and a memory card according to a first embodiment of the invention.

FIG. 2 illustrates a flow controller of the first embodiment.

FIG. 3 illustrates a register in the memory card.

FIG. 4 illustrates a configuration of a memory space of the memory card.

FIG. 5 illustrates a storage area recognized by the host and a storage area of the memory card.

FIG. 6 illustrates an address comparison unit in the memory card.

FIG. 7 illustrates an example of a command of the first embodiment.

FIG. 8 illustrates a sequential write control command and a signal that is transmitted or received subsequent thereto in the first embodiment.

FIG. 9 illustrates one state of the memory card and host device in a random write mode.

FIG. 10 illustrates a state subsequent to the state of FIG. 9.

FIG. 11 illustrates a state subsequent to the state of FIG. 10.

FIG. 12 illustrates a command transmitted from the host to the memory card in the first embodiment.

FIG. 13 illustrates one state of the memory card and host in a sequential write mode.

FIG. 14 illustrates a state subsequent to the state of FIG. 13.

FIG. 15 illustrates a state subsequent to the state of FIG. 14.

FIG. 16 illustrates a state subsequent to the state of FIG. 15.

FIG. 17 illustrates a state subsequent to the state of FIG. 6.

FIG. 18 illustrates a state subsequent to the state of FIG. 17.

FIG. 19 illustrates a state subsequent to the state of FIG. 18.

FIG. 20 illustrates a state subsequent to the state of FIG. 19.

FIG. 21 illustrates a state subsequent to the state of FIG. 20.

FIG. 22 illustrates a state subsequent to the state of FIG. 21.

FIG. 23 illustrates a state subsequent to the state of FIG. 22.

FIG. 24 illustrates a state subsequent to the state of FIG. 23.

FIG. 25 illustrates a state subsequent to the state of FIG. 24.

FIG. 26 illustrates a state subsequent to the state of FIG. 25.

FIG. 27 illustrates a state subsequent to the state of FIG. 26.

FIG. 28 illustrates a state subsequent to the state of FIG. 27.

FIG. 29 illustrates a state in which four AU buffers are provided.

FIG. 30 illustrates one state of the memory card and host device during data read.

FIG. 31 illustrates a state subsequent to the state of FIG. 30.

FIG. 32 illustrates a state subsequent to the state of FIG. 31.

FIG. 33 illustrates one state of a memory card and a host during data read in a second embodiment of the invention.

FIG. 34 illustrates a state subsequent to the state of FIG. 33.

FIG. 35 illustrates an example of a command according to a third embodiment of the invention.

FIG. 36 illustrates a sequential write control command and a signal that is transmitted or received subsequent thereto in the third embodiment.

FIG. 37 illustrates a sequential write control command and a signal that is transmitted or received subsequent thereto in the third embodiment.

FIG. 38 illustrates a sequential write control command and a signal that is transmitted or received subsequent thereto in the third embodiment.

FIG. 39 illustrates a mode state transition by the memory card of the third embodiment.

FIG. 40 illustrates an example of a register in the memory card of the third embodiment.

FIG. 41 illustrates the command transmitted from the host to the memory card in the third embodiment.

### DETAILED DESCRIPTION

Frequently a controller that controls a memory is incorporated in the memory device. The controller provides an instruction to write data to which a logical address is allocated in an unwritten storage area of the flash memory. The write instruction is requested from a file system of a host in which the memory device is inserted. The controller also manages a relationship between the logical address allocated to data by the file system and a position of a storage area of the flash memory in which the data is stored. A NAND flash memory is cited as a typical example of the flash memory used in the memory device.

A user may want to know performance of the memory device through the host device. Examples of the performance include a recording rate of the memory device, a time necessary for the recording, and a recordable time. For example, Jpn. Pat. Appln. KOKAI Publication No. 2006-178923 discloses a technique of predicting such performance.

A user uses the memory device in a diversified way as a result of an increased memory capacity, improved memory device performance, and various contents that the user desires to record. For example, there is a demand to concurrently record two moving images such as two television programs, or there is a demand to take a still image while the moving image is taken. However, data may need to be copied because data cannot be overwritten in the flash memory. Data copying requires a long time, and therefore the write rate involving the data copy is slow. Accordingly a plurality of pieces of file data cannot concurrently be written in the memory device in real time in response to the above demands.

In general, according to one embodiment, a memory device is disclosed. The memory device comprises a nonvolatile semiconductor memory and a controller. The nonvolatile semiconductor memory comprises storage areas. The controller receives write data items, has a random write mode and a sequential write mode, and transitions to the sequential write mode when receiving a start command. The controller in the sequential write mode recognizes a control command, and identifies one data stream which is partially formed by one write data item through the control command or a logical address. The controller in the sequential write mode also prepares free unit areas comprising a predetermined number of the storage areas for respective data streams, writes write data items in successive storage areas in a corresponding unit area in an order identical to addresses of the write data items. When the controller in the sequential write mode receives an end command, it performs end processing on a unit area for one corresponding data stream. The controller in the sequential write mode transitions to the random write mode when it completes the end processing to all of the data streams or detects a random write request.

Embodiments of the invention will be described below with reference to the drawings. In the following description, components having the substantially same function and configuration are designated by the same reference numeral, and overlapping description is provided only when it is needed. A final alphabet of the reference numeral is used to distinguish similar components from each other, and the alphabet is omitted when the components do not need to be distinguished from each other.

The following embodiments illustrate an apparatus and a method in order to embody the technical idea of the invention, which does not restrict a material, a shape, a structure, and an arrangement of components to the following example. In the technical idea of the invention, various changes can be made within claims.

Each functional block can be realized by hardware, computer software, or a combination thereof.

Therefore, each block is generally described from the viewpoint of function so as to be defined as any one of the hardware, computer software, and combination thereof. Whether the function is performed in the form of hardware or software depends on the specific embodiment or a design restriction imposed on a whole system. Those skilled in the art may realize the functions by various techniques in each specific embodiment, and any technique of realizing the function is included in the invention.

A memory card, particularly an SD card is described below as an example of a memory device according to embodiments of the invention. However, the following memory and any memory device comprising a controller that controls the memory are included in the invention.

### First Embodiment

### [1] Configuration

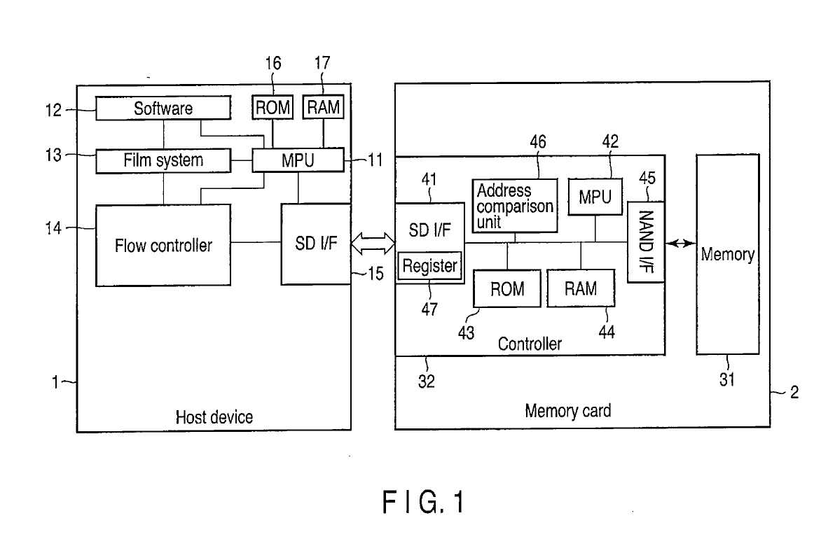

A configuration of a memory card according to a first embodiment of the invention will be described with reference to FIGS. 1 to 6. FIG. 1 illustrates main functional blocks of a host device 1 and a memory card 2 of the first embodiment. The host device (hereinafter referred to as a host) 1 comprises a micro processing unit (MPU) 11, software 12, a file system 13, a flow controller 14, an SD interface 15, a read only memory (ROM) 16, and a random access memory (RAM) 17.

The MPU 11 controls an operation of the whole of host 1. When power is supplied to the host 1, firmware (i.e., control program (, or commands)) stored in the ROM 16 is read out on the RAM 17. The MPU 11 performs predetermined processing according to the firmware (commands). The software 12 and the file system 13 are located on the ROM 16 or RAM 17, and the software 12 and the file system 13 each comprises a program including commands to cause the MPU 11 to perform predetermined processing. The software 12 comprises an application and an operating system, and a user provides an instruction to write data in the memory card 2 and an instruction to read the data from the memory card 2 through the software 12. The software 12 provides the instruction to write and read the data to the file system 13. The file system 13 is a mechanism that manages file data recorded in a storage medium of interest. The file system 13 records management information in a storage area of the storage medium and use it to manage the file data.

The SD interface 15 comprises hardware and software, which are necessary to interface between the host 1 and the memory card 2. The host 1 conducts communication with the memory card 2 through the SD interface 15. The SD interface 15 defines various protocols necessary to conduct communication between the host 1 and the memory card 2. The SD interface 15 comprises various sets of commands that can be recognized by an SD interface 41 of the memory card 2. The SD interface 15 also comprises a hardware configuration (arrangement of pins and the number of pins) that can be connected to the SD interface 41.

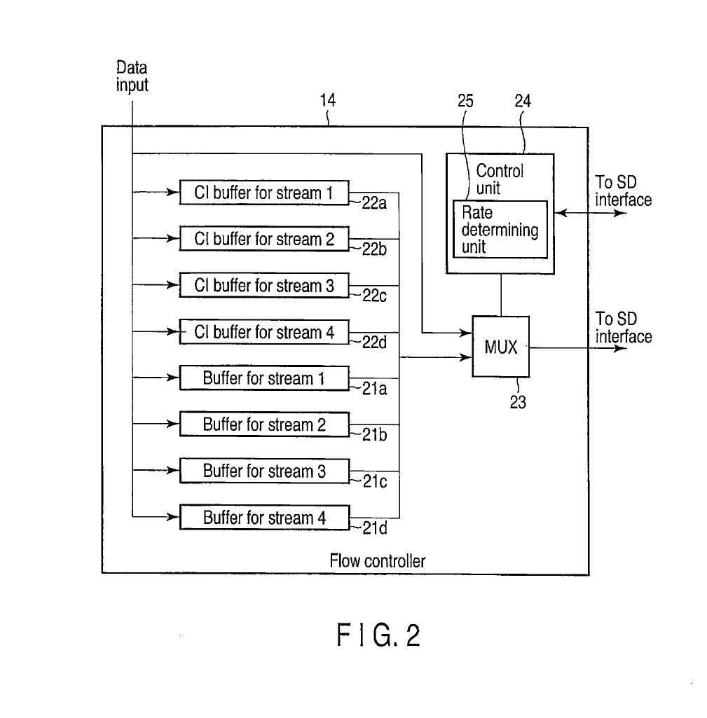

The flow controller 14 manages a flow of the data transmitted from the host 1 to the memory card 2. As illustrated in FIG. 2, the flow controller 14 comprises buffers 21a to 21d, buffers 22a to 22d for continuation information (CI), a multiplexer 23, and a stream control unit 24. The stream control unit 24 comprises at least a rate determining unit 25. The number of buffers 21a to 21d is equal to the number of data streams that are able to be concurrently written supported by the host 1 and the memory card 2. The number of buffers is four in FIG. 1, and hereinafter the description will be given in connection with such four buffers example. Each of the buffers 21a to 21d is provided for each stream, and data items of streams 1 to 4 are temporarily retained in the buffers 21a to 21d. Continuation information (CI) is temporarily retained in the buffer 22 for CI. The CI refers to information on a coupling sequence of equal-sized segments of write data for each stream. The CI is managed in each write data items that are divided into predetermined sizes for each stream. The CI is managed in each stream, and therefore the buffer 22 for CI may be independent in each stream. The host 1 (e.g., the MPU 11 according to the program) retains the CI on the divided write data in the buffer 22 for CI as needed while dividing the write data.

The stream control unit 24 controls the flow controller 14. The rate determining unit 25 determines a transfer rate of the data for each stream to the memory card 2 based on performance information (described later) on the memory card 2 and a transfer rate necessary for each stream. The stream control unit 24 controls the multiplexer 23 based on the determined transfer rate for each stream and an empty capacity of the buffer 22 for CI. Under the control of the stream control unit 24, the multiplexer 23 transmits the selected write data (part of write data) in the buffers 21 and 22 and other management data to the SD interface 15 according to the time-sharing principle.

The memory card 2 comprises a NAND flash memory 31 and a controller 32 that controls a memory 31. When the memory card 2 is connected to the host 1, or when the off-state host 1 with the memory card 2 inserted therein is powered, power is supplied to the memory card 2 followed by initialization of the memory card 2, and before the memory card 2 performs processing in response to an access from the host 1.

The memory 31 stores the data in a nonvolatile manner and writes and reads the data in a unit called a page including a plurality of memory cells. For example, the memory 31 comprises the NAND flash memory. A unique physical address is allocated to each page. The memory 31 erases the data in a unit called a physical block (erasure block) including a plurality of pages. The physical address may be allocated in units of physical blocks.

The controller 32 manages a data storage state of the memory 31. The management of the storage state includes management of a relationship which page (or physical block) of the physical address retains which data of the logical address and which page (or physical block) of the physical address is in the erased state (in which the page retains no or invalid data).

The controller 32 comprises the SD interface 41, an MPU 42, a RAM 44, a ROM 43, a NAND interface 45, and an address comparison unit 46.

The SD interface 41 comprises hardware and software, which are necessary to interface between the memory card 2 and the host 1. Similarly to the SD interface 15, the SD interface 41 defines various protocols which enable the memory card 2 and the host 1 to conduct communication with each other, and the SD interface 41 comprises various sets of commands and a hardware configuration (arrangement of pins and the number of pins). The memory card 2 (e.g., the controller 32) conducts communication with the host 1 through the SD interface 41. The SD interface 41 comprises a register 47.

The MPU 42 controls an operation of the whole of memory card 2. When the power is supplied to the memory card 2, firmware (i.e., control program (, or commands)) stored in the ROM 16 is read out on the RAM 17. The MPU 42 performs predetermined processing according to the firmware (commands). The MPU 42 produces various tables (described later) on the RAM 44 according to a control program and performs predetermined processing to the memory 31 in response to a command received from the host 1.

The control program executed by the MPU 42 is stored in the ROM 43. The RAM 44 is used as a work area of the MPU 42, and the control program and various tables are temporarily stored in the RAM 44. For example, the table includes a conversion table (logical-physical table), which describes a physical address of a particular page which stores data to which a particular logical address has been allocated by the file system 13. The NAND interface 45 performs interface processing between the controller 32 and the memory 31.

For example, the storage area in the memory 31 includes a system data area, a confidential data area, a protected data area, and a user data area classified according to types of retained data. The system data area refers to an area that is secured in the memory 31 by the controller 32 in order to retain the data necessary for its operation. Key information used in encryption and confidential data used in authentication are retained in the confidential data area, which is inaccessible by the host 1. Important data and secure data are stored in the protected data area. The host 1 can access and use the user data area and, for example, pieces of user data such as an AV content file and image data are stored in the user data area. In the following description, when the description of the memory 31 is used in the sense of a memory space of the memory 31, the description shall mean the user data area. The controller 32 secures part of the user data area to retain control data (such as the logical-physical table) necessary for the operation thereof.

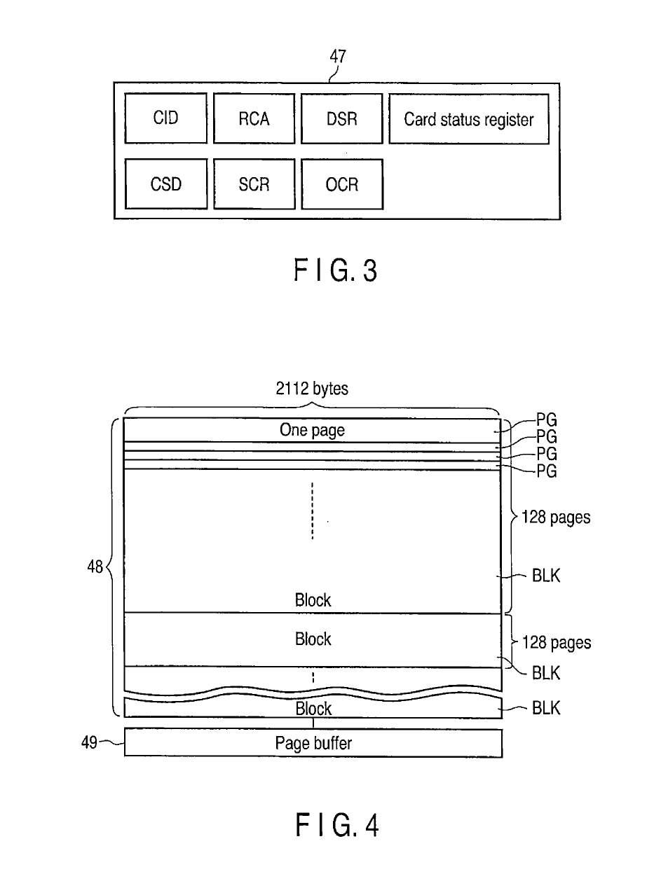

As illustrated in FIG. 3, the register 47 comprises various registers such as a card status register, a CID, an RCA, a DSR, a CSD, an SCR, and an OCR. Error information, an individual number of the memory card 2, a relative card address, a bus driving voltage of the memory card 2, characteristic parameter values of the memory card 2, a data arrangement, and an operating voltage in the case where a restriction exists in an operating range voltage of the memory card 2 are stored in the registers.

A class of the memory card 2, a time required to copy the data, and an AU size are stored in the register 47 (for example, CSD). The class is defined by the lowest write rate that is guaranteed by a memory card belonging to a particular class. The highest write rate is defined depending on the class. Accordingly, the host 1 can read the data indicating the AU size from the register 47 to utilize the information in managing the memory card 2 and can read the data indicating the class from the register 47 to learn the maximum write performance of the memory card 2. Further, for example, performance information described in Jpn. Pat. Appln. KOKAI Publication No. 2006-178923 may be stored in the CSD.

FIG. 4 illustrates a configuration of the memory space of the memory 31. As illustrated in FIG. 4, the memory 31 comprises a normal memory area 48 and a page buffer 49. The memory area 48 comprises a plurality of physical blocks BLK. Each physical block BLK comprises a plurality of pages PG. Each page PG comprises an a series of bits stored in a plurality of series-connected memory cell transistors.

Each memory cell comprises a metal oxide semiconductor field effect transistor (MOSFET) having a so-called stacked gate structure. In each cell transistor, a threshold voltage varies according to the number of electrons accumulated in the floating gate electrode, and information is stored according to a difference of the threshold voltage. The memory 31 may be configured such that the cell transistor takes two or more states of different threshold voltages, that is, multi-values (multi-bits) are stored in the memory cell.

Control gate electrodes of the cell transistors belonging to the same row are connected to the same word line. Select gate transistors are provided at both ends of the series-connected cell transistors belonging to the same column. One of the select gate transistors is connected to a bit line. The data is written and read in units of sets of the series-connected cell transistors, and the storage area comprising the set of the cell transistors corresponds to one page.

For example, each page PG has 2112 bytes, and each block BLK has 128 pages. The data is erased in units of blocks BLK. The data to the memory 31 and the data from the memory 31 are temporarily retained in the page buffer 49.

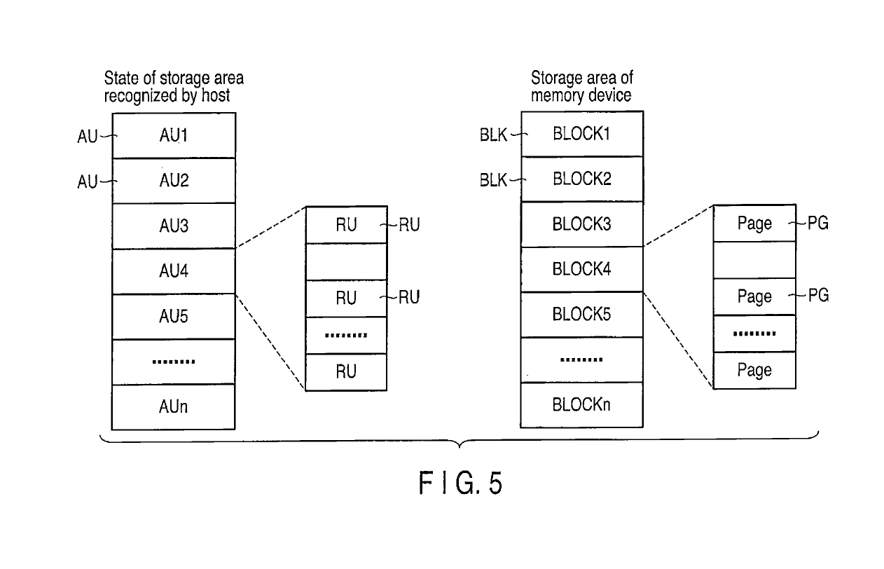

As illustrated in FIG. 5 and described above, the memory 31 writes and reads the data in units of pages PG and erases the data in units of blocks BLK. On the other hand, the application software 12 that performs real-time recording manages the data in units of recording units (RUs). The RU corresponds to a unit to which data is written by one multi-block write command. Following a write command, the application software 12 transmits the data to which a unique logical address is allocated to the memory card 2. The controller 32 writes the write data in a proper page. A size of the RU is an integral multiple of a size of the page capacity. Accordingly, in the memory card 2, the write data having the size of the RU is written in the plurality of pages having the successive physical addresses. The allocation of the data to the RU becomes synonymous with the allocation of the logical address to the data because each RU corresponds to the unique logical address managed by the file system. The file system 13 manages a connection relationship between the divided data items using a table, and connects the divided data items using the connection relationship to restore the original data. Using a conversion table (logical-physical table), the controller 32 manages a correlation between the logical address and the address (physical address) of the page in which the data of the logical address is stored.

The application software 12 performs management using a concept of an allocation unit (AU) comprising the predetermined number of successive RUs belonging to a predetermined range. The controller 32 can recognize a border of the AU by referring to higher-digit bits of the logical address of the data. A size of the AU is an integral multiple of a size of the capacity of the block (physical block). Thus, the RU is matched with the size of the natural number of pages, and the AU is matched with the size of the natural number of blocks. Therefore, the following description is made with the RU and the AU as the unit of the data read/write in the memory card 2. That is, the word of the RU used in the description about the memory card 2 means the plurality of successive pages having the same size as the RU, and the word of the AU used in the description about the memory card 2 means the plurality of successive block having the same size as the AU. Specifically, the data that the application software 12 allocates to the RU is written in a certain RU of the memory card 2, and the memory card 2 manages the RU (logical address) that the application software 12 allocates to the data and the RU in the memory 31 in which the write data is stored using a table. Hereinafter, the AU recognized by the application software 12 and the AU of the memory 31 may be referred to as a logical AU and a physical AU, respectively.

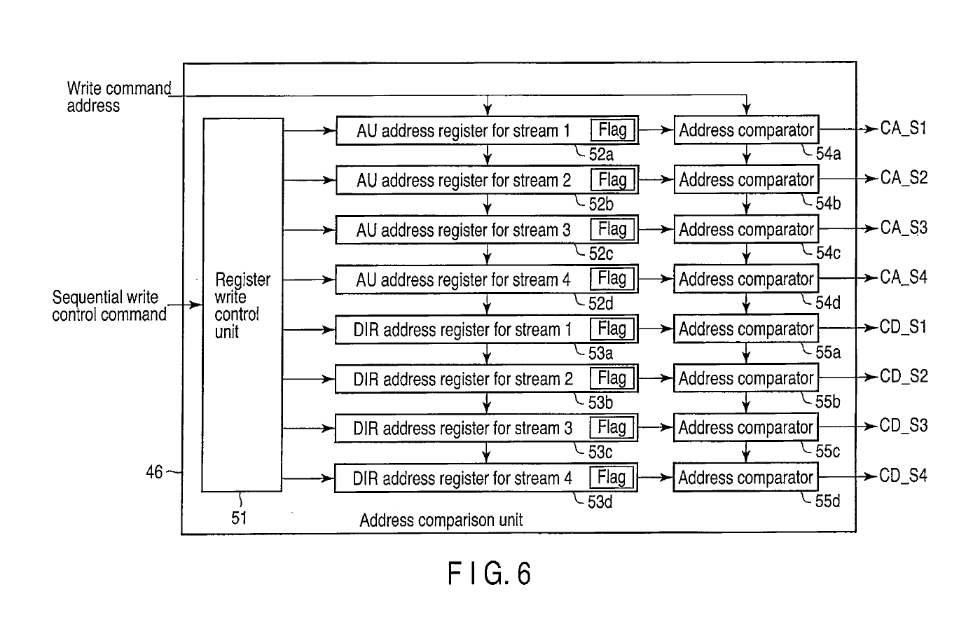

As illustrated in FIG. 6, the address comparison unit 46 comprises a register write controller 51, AU address registers 52a to 52d for streams, DIR address registers 53a to 53d for streams, comparators 54a to 54d for AU address registers for streams, and comparators 55a to 55d for DIR address registers for streams. In an example of FIG. 6, the four streams are supported by the host 1 and the memory card 2.

The register write controller 51 receives the command issued from the host 1 through the SD interface 41. The AU address registers 52a to 52d, the DIR address registers 53a to 53d, and the address comparators 54a to 54d and 55a to 55d receive RU addresses (write (RU) address) of the write command, in which the write data items should be stored, from the SD interface 41. In the AU address registers 52a to 52d and the DIR address registers 53a to 53d, the register specified by the register write controller 51 retains the write RU address or the AU address to which the write RU address belongs. As described above, the AU address of the RU address can be specified from the RU address. The registers 52 and 53 include flags indicating whether the address stored therein is valid.

The address comparators 54a to 54d and 55a to 55d are connected and correspond to the address registers 52a to 52d and 53a to 53d, respectively. The address comparators 54 and 55 compare the AU address of the write data to the addresses (or AU addresses) retained in the corresponding address registers 52 and 53. As a result of the comparison, when the compared addresses are matched, the address comparators 54a to 54d and 55a to 55d output asserted CA_S1, CA_S2, CA_S3, CA_S4, CD_S1, CD_S2, CD_S3, and CD_S4, respectively. A specific operation of the address comparison unit 46 is described later in detail.

### [2] Operation

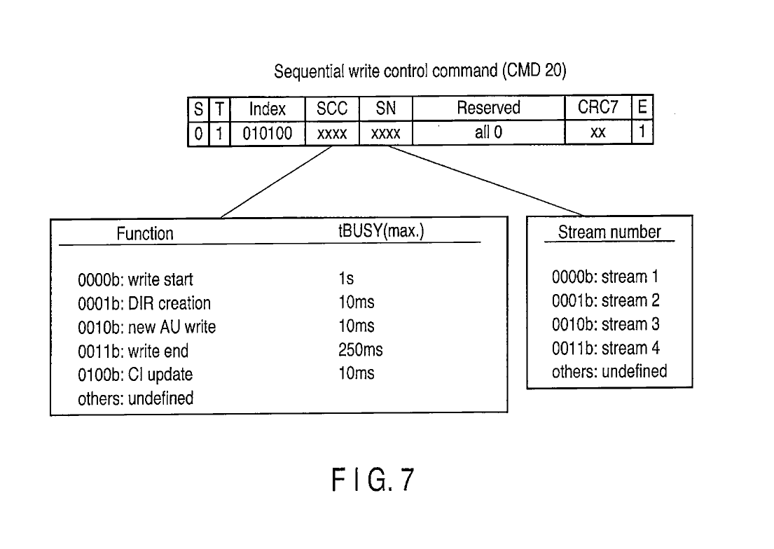

Operations of the host and memory card will be described with reference to FIGS. 7 to 32.

The SD interfaces 15 and 41 are configured to be able to recognize a command illustrated in FIG. 7. FIG. 7 schematically illustrates a sequential write control command of the first embodiment. As illustrated in FIG. 7, the sequential write control command (CMD 20) includes at least an index portion index, an operation specifying portion SCC, a stream number portion SN, and a cyclic redundancy check (CRC) portion CRC. The index portion has a specific line of bits in order to specify that the command is the sequential write control command. The operation specifying portion SCC has a specific bit sequence in order to specify a kind of the operation assumed by the sequential write control command. The sequential write control command acts as a command to perform one of write (recording) start, directory entry (DIR) creation, new AU write, write (recording) end, and CI update according to an argument in the operation specifying portion SCC. The stream number portion SN includes an argument that specifies which of streams 1 to 4 corresponds to the sequential write control command. Meaning of each command is described later. The CRC portion has a CRC code.

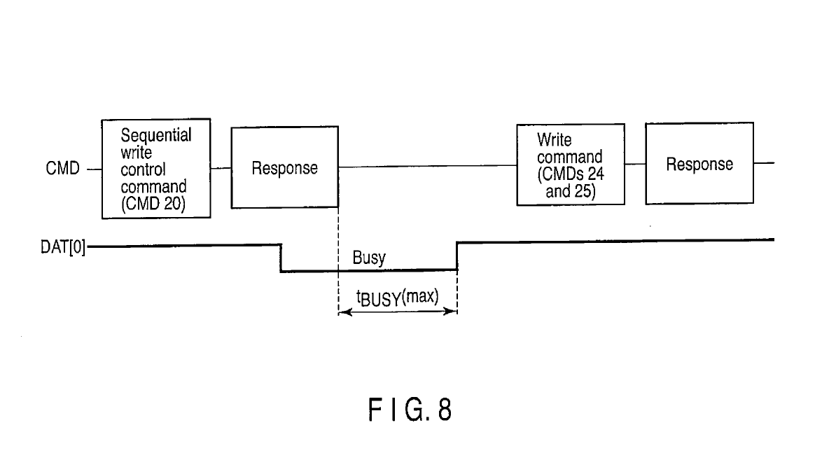

FIG. 8 illustrates the sequential write control command and a signal that is transmitted and received subsequent thereto between the host and the memory card. As illustrated in FIG. 8, at least a command line (CMD) and a data line (DAT[0]) are defined in the SD interfaces 15 and 41. When the host 1 transmits the sequential write control command on the command line, the memory card 2 transmits a response on the command line. When the sequential write control command is received by a memory card that does not recognize the command, the memory card does not transmit the response. The memory card transmits a busy signal to the host 1 on the data line while transmitting the response. The maximum time t_{busy}(max) for which the memory card can remain in a busy state is predetermined according to a function of the sequential write control command, and FIG. 7 illustrates the functions of the sequential write control command.

After the busy state is released, the host 1 transmits the write command (CMDs 24 and 25) to the memory card 2 on the command line. In principle, the host 1 issues the write command after the sequential write control command. The reason will be described later. The memory card 2 transmits the response to the write command to the host 1 on the command line. Then the host 1 transmits the write data to the memory card 2 on the data line.

The data write in the memory card 2 by the host 1 will be described below.

[2-1] Random Write Mode

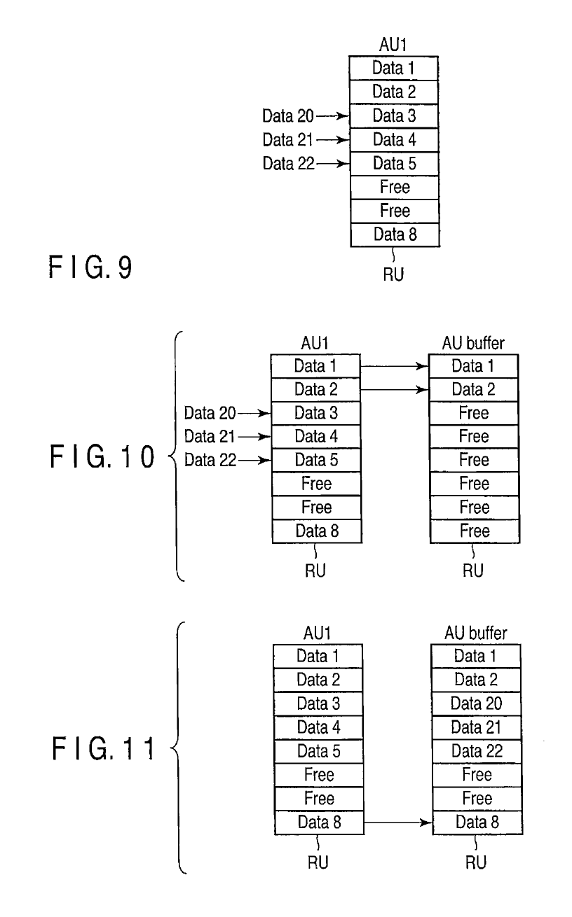

Usually the host 1 is in the random write mode. First the random write mode will be described with reference to FIGS. 9 to 11. FIGS. 9 to 11 each illustrate one state of the memory card 2 and the host 1 in the random write mode.

In the memory card 2, data items 1 to 5 and 8 are stored in first to fifth RUs and eighth RU of the AU 1, respectively. The data is not allocated to sixth and seventh RUs. At this point, the host 1 desires to write data 20 to data 22 in the third to fifth RUs of the AU 1 (this corresponds to the overwriting). However, the memory 31 performs the following operation because the memory 31 cannot directly perform the update instruction by overwriting the data. As illustrated in FIG. 10, the memory card 2 (controller 32) prepares an AU buffer for internal processing of the memory card 2. The AU buffer is realized by the AU that is not yet correlated with the AU recognized by the host 1 in the Aus included in the memory card 2. The memory card 2 copies the data 1 and data 2 to the first and second RUs identical to the RUs of the AU 1 that are not updated in the AU buffer, respectively. The AU buffer dedicated for the random write mode may be provided, or an AU buffer for each stream that is secured in a sequential write mode may be reused, as described later. This is because the AU buffer used in the sequential write mode has no application in other modes.

As illustrated in FIG. 11, the memory card 2 writes the data 20 to data 22 in the third to fifth RUs in the AU buffer 1 that are identical to the to-be-updated RUs of the AU 1. Then the memory card 2 copies the data 8 of the AU 1 to the eighth RU in the AU buffer identical to the un-updated RU of the AU 1. Then the memory card 2 performs fixing processing to the AU buffer 1. The fixing processing refers to setting the AU buffer to a proper AU, that is, the logical-physical table is updated to indicate that the AU buffer now stores the data in the AU recognized by the file system 13. At the same time, the physical AU which has stored the data of the logical AU 1 before the fixing processing will be treated as having the invalid data. The data of the old physical AU is erased at predetermined timing to become a new erased AU.

The same processing as the update request is similarly performed in response to instruction requiring no update. That is, assume an example in which the third to fifth RUs are erased in FIG. 9 while other RUs are identical those of FIG. 9, then the data 1 and data 2 are copied to the first and second RUs of the AU buffer, the data 20 to data 22 are written in the third to fifth RUs, and the data 8 is copied to the eighth RU, followed by the fixing processing.

In the random write mode, in response to the update or write request, the data items in the RU except the to-be-updated or written RU are copied to the AU through the copy to the AU buffer.

[2-2] Sequential Write Mode

The memory card 2 has the sequential write mode. In the sequential write mode, the memory card 2 writes the data differently from that of the random write mode. In the sequential write mode, the memory card 2 always writes the data in the erased AU such that the sequence of the logical addresses of the data is matched with the sequence of the addresses of the RUs which store the data, that is, the memory card 2 sequentially writes the data.

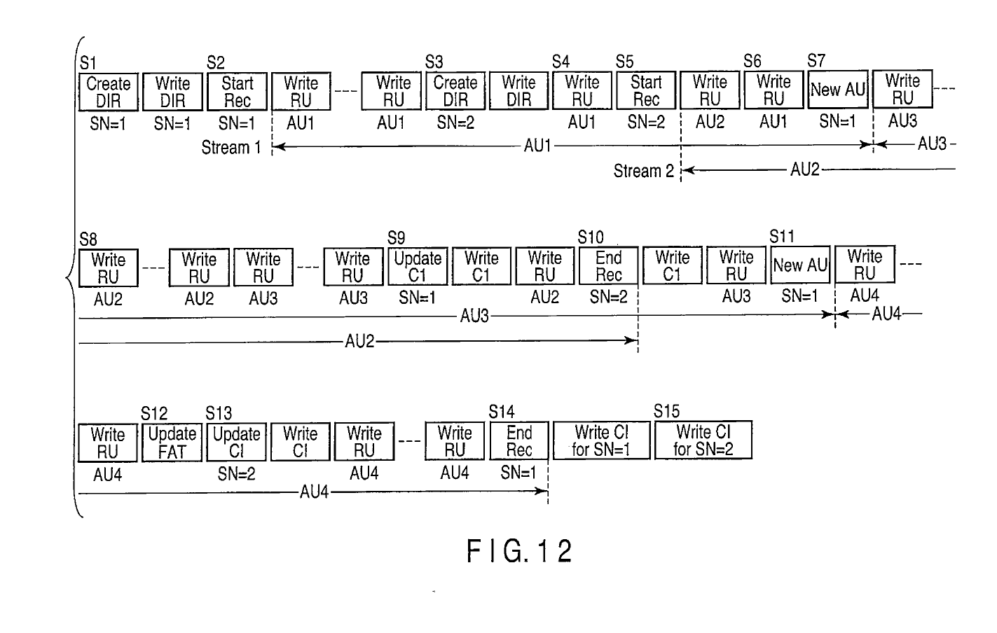

The memory card 2 transitions to the sequential write mode when receiving the sequential write control command that has the argument specifying start of the data write in the operation specifying portion SCC. The memory card 2 is configured to be able to write the plurality of stream in the memory card in the sequential write mode. The sequential write mode will be described with reference to FIGS. 12 to 28. FIG. 12 illustrates commands transmitted from the host to the memory card 2 in time series.

In the following description, a sequential write control command to which a certain function is specified is by its operation specifying portion SCC will be referred to as a command having such a function. That is, the sequential write control commands that instructs write start, DIR creation, new AU write, write end, and CI update are referred to as a write start command, a DIR create command, a new AU write command, a write end command, and a CI update command, respectively.

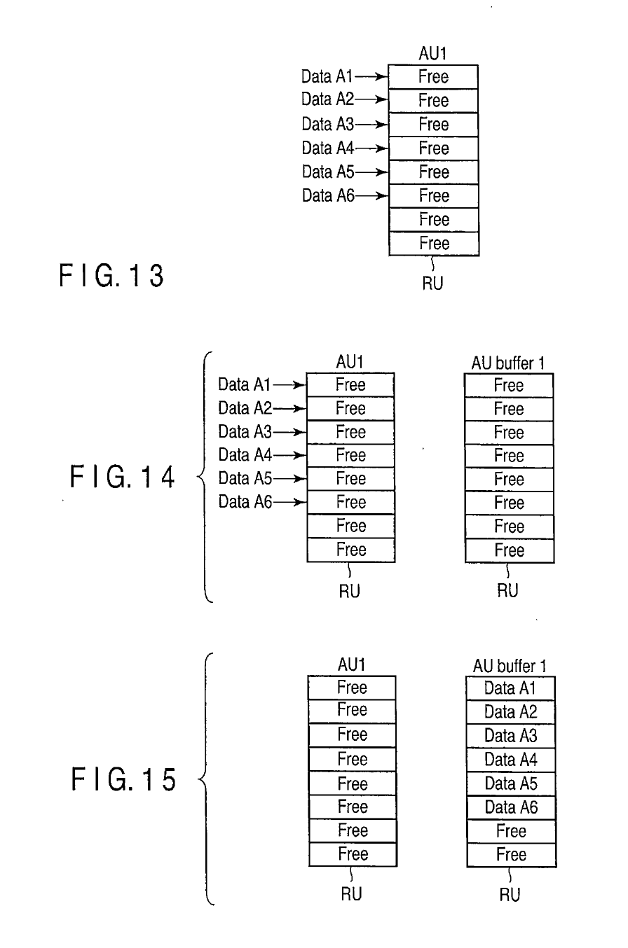

As illustrated in FIG. 13, in the sequential write mode, the host 1 requests to write data items A1 to A6 for the stream 1 in the AU 1. To this end, the host 1 prepares for the write start of the stream 1 (Step S1). Specifically, the host 1 issues a DIR create command (Create DIR). The DIR create command has the argument indicating the stream 1 because of writing of first stream (SN=1). When receiving this command, the memory card 2 secures a logical address for the DIR for the stream 1 therein.

Then the host 1 transmits the write command and the write data, which are integrally illustrated as a command “Write DIR”, to the memory card 2. The write command is specified by the last DIR create command as for writing the DIR, and therefore the write command is referred to as a DIR write command. The DIR data is written in the dedicated AU buffer that is prepared in the memory card 2 in response to the DIR create command, and the fixing processing (end processing) is performed to the AU buffer.

The host 1 can recognize which stream data to be written by the write command is for. On the other hand, the memory card 2 cannot recognize the stream number from the write command because the write command does not include the argument specifying the stream number. Therefore, the sequential write control command is issued before the write command for a new stream, and the stream number directed by the write command is clearly indicated by the sequential write control command. Based on the stream number, the memory card 2 can learn which stream data to be written by the write command is for. Specifically, the processing is performed according to the following method using the address comparison unit 46 (FIG. 6).

When receiving the sequential write control command, the register write controller 51 can recognize the stream directed by the subsequent write command from the sequential write command. The register write controller 51 can also recognize the operation requested by the sequential write command from the argument in the operation specifying portion of the sequential write control command. When the write command is the DIR update command or the write start command (the sequential write control command assuming the write start command), the write command is the DIR write command or the command to write the data for a stream (data write command). When receiving the DIR write command, the register write controller 51 stores the logical address of the write address of the DIR write command in one of the DIR address registers 52a to 52d based on the corresponding stream, and sets its flag to “valid”. Similarly, when receiving a data write command, the register write controller 51 stores the AU address of the write address of the data write command in one of the AU address registers 53a to 53d based on the corresponding stream, and sets its flag to “valid”. Each time the address comparison unit 51 receives a new write command in the sequential write mode, the address comparison unit 51 compares the write address in the write command or the AU address to the addresses stored in the registers 52 and 53. The memory card 2 can specify the stream directed by the write command by the comparison. The detailed comparison is described when the comparison occurs in the description of FIG. 12.

The description is continued referring to FIG. 12. Step S2 is for writing the data for the stream 1. First, the host 1 transmits the write start command (Start Rec) that has the argument specifying the stream 1 to the memory card 2. When receiving this write start command, the memory card 2 transitions to the sequential write mode. In the sequential write mode, the memory card 2 prepares an unwritten AU buffer dedicated to each stream, and sequentially writes the write data items from the RU of the lowest address in the prepared AU buffer toward the RU of higher address. Accordingly, when receiving this write start command, the memory card 2 prepares the AU buffer 1 for stream 1 therein as illustrated in FIG. 14. Data may remain in the prepared AU buffer 1 due to reuse of it in the last random write mode. In such a case, the memory card 2 performs to the AU buffer 1 the fixing processing including the copy of the valid data in the AU buffer 1. The memory card 2 uses the new erased AU as the new AU buffer 1 in the following processing after disabling the old AU buffer 1 of the preceding fixing processing. When the AU buffer is prepared after the fixing processing, the busy time is longer than that for without using the AU buffer in both the modes or than that for the preparation of the recording start of the data items for the streams 2 to 4.

Then the host 1 issues the write command (Write RU). The write command is for writing the actual data (stream data) because the write command directly follows the write start command. The memory card 2 recognizes that the data write command is for the stream 1 from the preceding write start command. Therefore, the register write controller 51 (FIG. 6) stores the AU address of the address of the data write command in the AU address register for stream-1 52a, and the register write controller 51 sets its flag to “valid”. The address comparators 54 and 55 compare the AU addresses of the write addresses to the valid addresses in the corresponding address registers 52 and 53. In the normal operation, the AU address to which the DIR write address belongs does not match with that of the data write address, for any stream. The DIR and the data having the identical AU means that sequential write cannot be performed and host requests illegal processing, then the memory card 2 terminates the processing.

After the data write command, the host 1 sequentially transmits the write data for the stream 1 to the memory card. Note that the write data and the write command are integrally illustrated in the drawings. For continuous writing of the data for the same stream without interruption, only the write command may be issued at the beginning of the sequence of write data items. As illustrated in FIG. 15, when receiving the write data, the memory card 2 sequentially writes the write data from the RU of the unwritten lowest address of the AU buffer 1 toward the RU of a higher address.

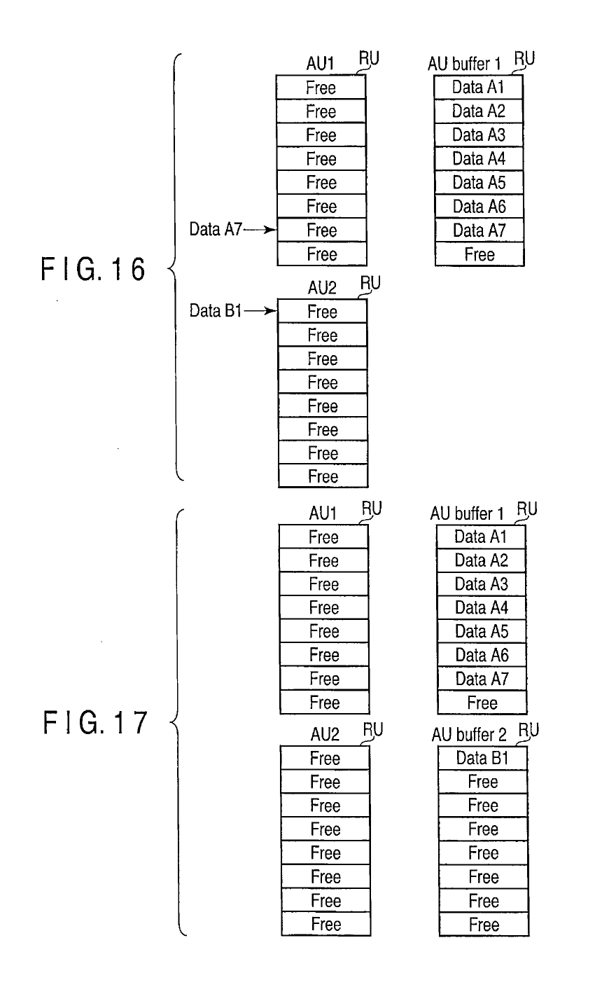

As illustrated in FIGS. 12 and 16, the host 1 requests to write data B1 for the stream 2 in the AU 2 during the write of the stream 1. To this end, the host 1 prepares for the write start of the stream 2 (Step S3). Specifically, the host 1 issues a DIR create command for the stream 2. When receiving this command, the memory card 2 stores the write (logical) address included in the command in the DIR address register for stream-2 53b, and sets its flag to “valid”. When receiving the DIR write command, the memory card 2 secures the AU for the DIR for the stream 2 therein.

Using the class information read from the memory card 2, the stream control unit 24 determines whether the stream 2 can be written together with the stream 1 at a bit rate requested by the software (application) 12. When the write of the stream 2 is not accepted in addition to the currently written stream 1, for example, the host 1 does not write the stream 2, and notifies the user of it. The host 1 determines how many streams are acceptable when receiving the request to write a new stream. However, an upper limit of the number of acceptable streams is fixed by another restriction. That is, the number of acceptable streams is determined by the number of buffers 21 and 22 and the number of registers 52 and 53, which are supported by the host 1 and the memory card 2. The following description assumes that the request to write the stream 2 is acceptable.

After the DIR create command, the host 1 transmits the DIR write command and DIR data for the stream 2 to the memory card 2. All the address comparators 54 and 55 compare the logical addresses in the DIR write command for the stream 2 to the valid addresses in the address registers 52 and 53. No matching should occur for normal operation. The memory card 2 writes the DIR data for the stream 2 in the AU of the assigned address or the AU buffer.

As illustrated in FIGS. 12 and 16, the host 1 requests to write data A7 for the stream 1 in AU 1 (Step S4). To this end, the host 1 transmits the data write command and data A7 for the stream 1 to the memory card 2. As described above, because the write command has only the address information in its argument, a lone write command without preceding sequential write control command cannot indicate for which stream it is for. To deal with this, the memory card 2 uses the address comparison unit 46 to determine the stream number to which the write command corresponds. That is, the address comparators 54 and 55 compare the write addresses to the addresses in the corresponding registers 52 and 53. As a result of the comparison, one of the address comparators 54a to 54d (the comparator 54a in this example), which stores the address matched with the write address, outputs one of the signals CA_S1 to CA_S4 (the signal CA_S1 in this example,) to the MPU 42. From this signal, the memory card 2 learns that the stream corresponding to the address register 52 retaining the address matched with the write address (or the AU address of the write address), which is the stream 1 in this example, is the stream directed by the write command. Accordingly, the controller 32 writes write data A7 in the seventh RU of the unwritten lowest address of the AU buffer 1 for stream 1.

As illustrated in FIGS. 12 and 17, the host 1 continues the write of the data for the stream 2 (Step S5). To this end, the host 1 issues a write start command for the stream 2 (SN=2). When receiving this write start command, the memory card 2 prepares the AU buffer 2 for stream 2 in the memory card 2. The same number of AU buffers for the streams as the number of concurrently-writable streams supported by the host 1 and the memory card 2 is prepared. Then the host 1 transmits the data write command and the data B1 for the stream 2 to the memory card 2. This data write command directly follows the data write start command that clearly indicates the stream number. Therefore, the memory card 2 recognizes that the data write command is for writing the data for the stream 2, and the register write controller 46 stores the AU address of the write address in the AU address register for stream-2 52b (FIG. 6). No matching of the AU addresses occur in the address comparison unit 46. Then the memory card 2 writes the data B1 in the first RU of the unwritten lowest address of the AU buffer 2.

Writes of the data for the streams 1 and 2 are concurrently progressing after the write start of the data B1. Therefore, the host 1 transmits the data for the stream 1 and the data for the stream 2 to the memory card 2 according to the time-sharing principle. The bit rates of the data for the streams 1 and 2 are determined by the stream control unit 24 of the flow controller 14 (FIG. 2) for time sharing. The multiplexer 23 sequentially transmits the data items to the memory card 2 according to the control based on this determination. The stream control unit 24 performs the determination of each bit rate according to the rate determining unit 25. For example, in initializing the memory card 2, the rate determining unit 25 reads the class information and the information on the AU size from the memory card 2 and stores it. The rate determining unit 25 uses the bit rate requested for each stream according to the application (application software 12) and the class information (lowest write speed) to determine the bit rate used for transmitting the data for each stream from the host 1 to the memory card 2. That is, the amount of data and the transmitted sequence for individual streams are determined such that the bit rate for each stream, requested by the application, can be realized. The stream control unit 24 is usually implemented by software because such determination is required. Alternatively, the stream control unit 24 may be formed by the hardware.

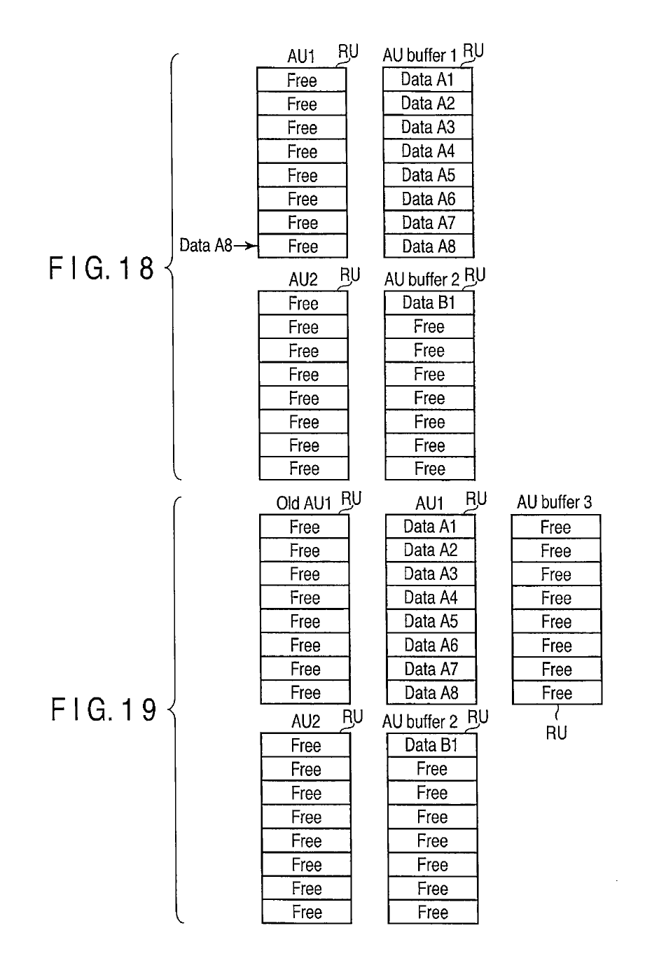

As illustrated in FIGS. 12 and 18, the host 1 requests to write the data A8 for the stream 1 in the AU 1 (Step S6). To this end, the host 1 transmits the data write command and the data A8 to the memory card 2. As described above with reference to FIG. 6, the address comparison unit 46 compares the AU addresses of the write addresses to recognize that the data A8 is for the stream 1. Therefore, as illustrated in FIG. 18, the memory card 2 writes the data A8 in the eighth RU of the unwritten lowest address of the AU buffer 1.

The data items are written in all the RUs of the AU 1 because of the write of the data A8. In order to continue the write of the data for the stream 1 the host 1 requests to produce a new AU buffer for the stream 1 (Step S7). To this end, as illustrated in FIGS. 12 and 19, the host 1 transmits a new AU write command (New AU) for the stream 1 to the memory card 2. When receiving the new AU write command, the memory card 2 performs the fixing processing to the current AU buffer for the stream 1 (AU buffer 1). As a result, the logical-physical table is updated to indicate that the AU buffer 1 now corresponds to the logical AU 1. Then the memory card 2 secures a new AU buffer for the stream 1 (AU buffer 3). The register write controller 51 (FIG. 6) clears the AU address stored in the AU address register for stream-1 52a and its flag.

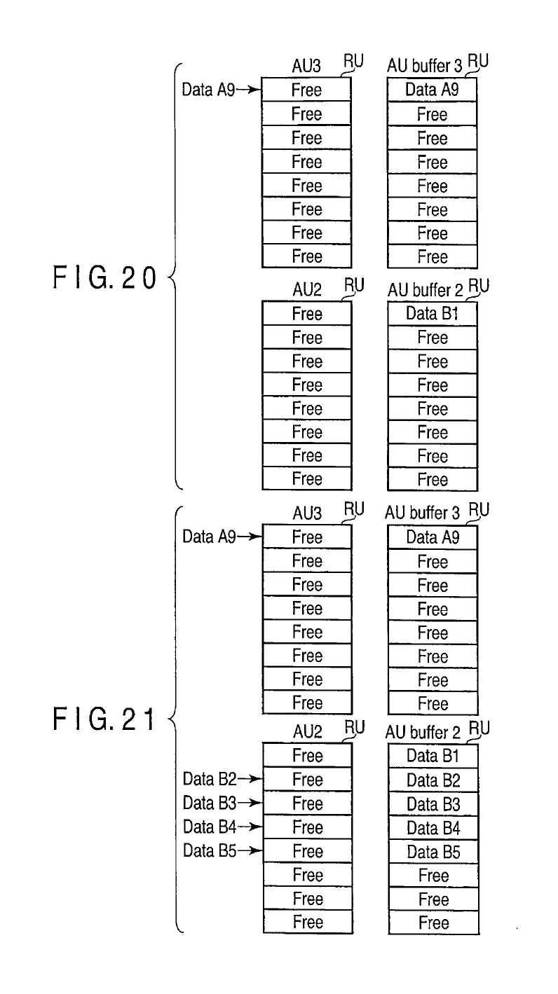

Then the host 1 requests to write data A9 for the stream 1 in the AU 3. To this end, the host 1 transmits the data write command and the data A9 to the memory card 2. From the preceding new AU write command, the memory card 2 recognizes that the data write command is for writing the data for the stream 1. Therefore, the register write controller 51 (FIG. 6) stores the AU address of the write address in the AU address register 52a for stream 1, and sets its flag to “valid”. Although the address comparators 54 and 55 perform the comparison, no matching should occur. Then, as illustrated in FIG. 20, the memory card 2 writes the data A9 in the first RU of the unwritten lowest address of the AU buffer 3.

Then the host 1 writes data items A10 to A15 for the stream 1 in the AU 3, and the host 1 writes data items B2 to B5 for the stream 2 in the AU 2. To this end, the rate determining unit 25 determines to transmit, for example, the data items B2 to B5 for the stream 2 to the memory card 2, first. Based on this determination, the host 1 transmits the data write command and the data items B2 to B5 to the memory card 2 as illustrated in FIGS. 12 and 21 (Step S8). As described above with reference to FIG. 6, the address comparison unit 46 compares the AU addresses of the write addresses to recognize that the data items B2 to B5 are for stream 2. Therefore, the memory card 2 writes the data items B2 to B5 in the second RU of the unwritten lowest address and following third RU to fifth RU of the AU buffer 2, respectively.

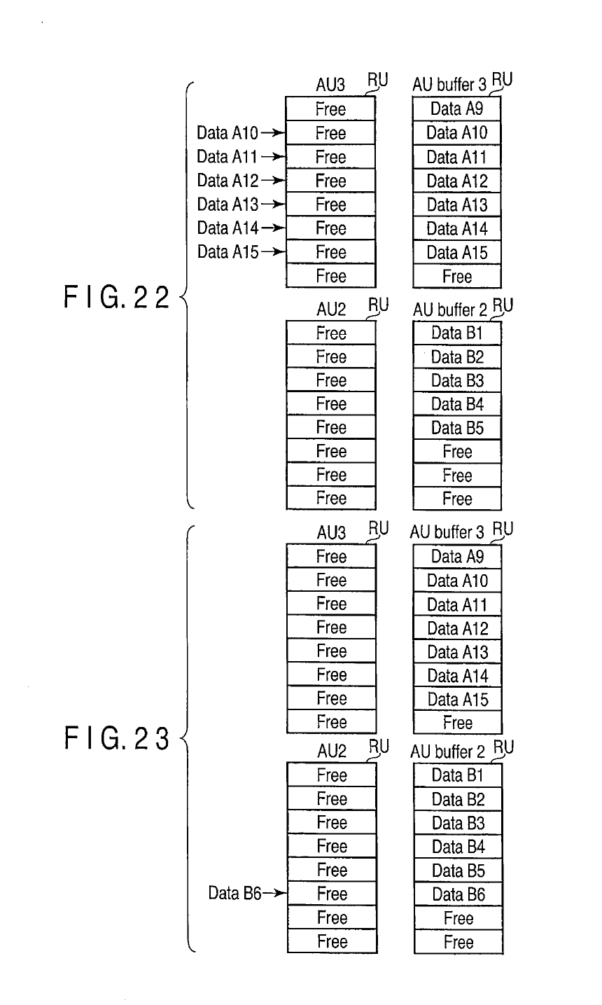

As illustrated in FIGS. 12 and 22, the host 1 transmits the data write command and data items A10 to A15 to the memory card 2. As described above with reference to FIG. 6, the address comparison unit 46 compares the AU addresses of the write addresses to recognize that the data items A10 to A15 are for stream 1. Therefore, the memory card 2 writes the data items A10 to A15 in the second RU of the unwritten lowest address and following third to sevenths RU of the AU buffer 3, respectively. Thus, the data items are distributed to the AU buffers for the corresponding streams, and the sequential data write is maintained for each stream. Therefore, the time necessary to the write and read the data is shorter than that of the random write.

As described above, the CI is retained in the buffer 22 for CI. However, the CI may sometimes grow too large to fit in the buffer for CI according to a buffer size and a stream length. In such cases, the host 1 requests to write at least part of the current CI in the buffer secured for the CI in the memory card 2 after detecting that the buffer for CI of the flow controller 14 is filled (Step S9). To this end, the host 1 transmits a CI update command for a specific stream (the stream 1 in this example) to the memory card 2. Then the host 1 transmits the write command and the CI data to the memory card 2. From the preceding CI update command, the memory card 2 recognizes that the write command is for write the CI data (CI write command). The address comparison unit 46 compares the write address (or the AU address of the write address) to the addresses in the registers 52 and 53 as usual; however no matching should occur except the illegal sequence required. If a matching occurs, the memory card 2 transmits an error signal to the host 1 as well as terminating the processing because the host 1 requests to perform the illegal processing. Note that the AU address of the address in the CI write command is not stored in the address register.

The memory card 2 writes the CI data in the buffer for CI when receiving the CI data. The CI data needs to have a particular size or less because the CI data is also written according to the time-sharing principle in the sequential write mode. Therefore, the write of the CI data is interrupted even if the write of the CI data is not completed. The remaining CI data is written by the next CI update command in another time slot, or the remaining CI data is written after the sequential write mode finishes.

As illustrated in FIGS. 12 and 23, the host 1 requests to write data B6 for the stream 2 in the AU 2. To this end, the host 1 transmits the data write command and the data B6 to the memory card 2. As described above with reference to FIG. 6, the comparison address unit 46 compares the AU addresses of the write addresses to recognize that the data B6 is for the stream 2. Therefore, the memory card 2 writes the data B6 in the sixth RU of the unwritten lowest address of the AU buffer 2.

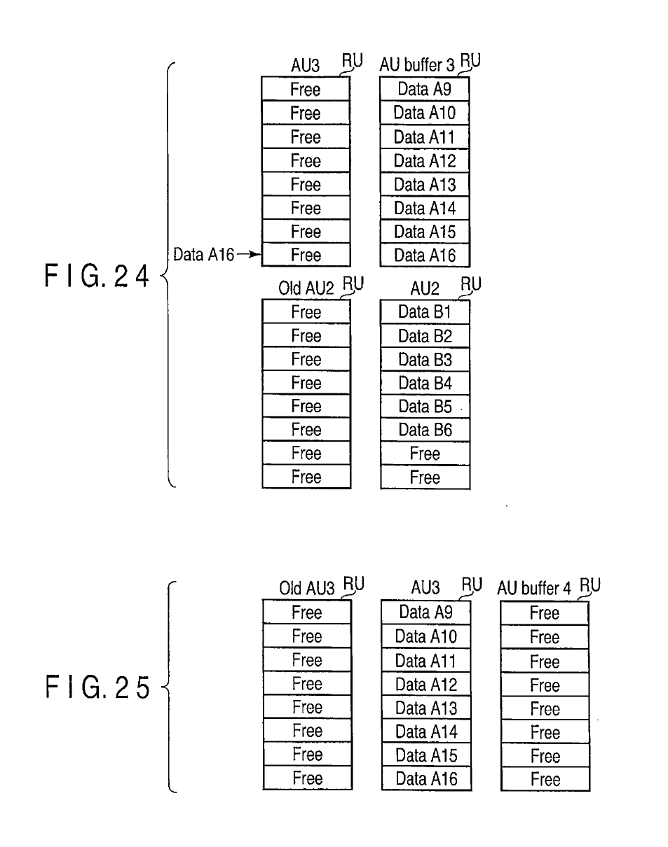

Assume that the data B6 is the final data for the stream 2, then the host 1 transmits the write end command (End Rec) for the stream 2 to the memory card 2 as illustrated in FIGS. 12 and 24 (Step S10). When receiving the write end command, the memory card 2 performs the fixing processing to the AU buffer (AU buffer 2) that is currently valid for the designated stream similarly to the new AU write command. As a result, the logical-physical table is updated to indicate that the AU buffer 2 now corresponds to the logical AU 2. In the fixing processing, even if the data is allocated to the RU positioned higher than the RU finally used in the logical AU 2 (the seventh and eighth RUs in this example), such data is not copied to the AU buffer (AU buffer 2). In response to the write end command, the register write controller 51 clears the AU address stored in the address register for the corresponding stream (the stream 2 in this example) and its flag.

After the write end command, the host 1 transmits the CI update command and CI data for the stream (stream 2) designated by the write end command to the memory card 2. However, as described above, the write of the CI data may not complete because the CI data is written within the framework of the time sharing in the sequential write mode.

Then the host 1 requests to write data A16 for the stream 1 in the AU 3. To this end, the host 1 transmits the data write command and the data A16 to the memory card 2. As described above with reference to FIG. 6, the address comparison unit 46 compares the AU addresses of the write addresses to recognize that the data A16 is for the stream 1. Therefore, the memory card 2 writes the data A16 in the eighth RU of the unwritten lowest address of the AU buffer 3.

The data items are written in all the RUs in the AU buffer 3, and therefore the host 1 requests to create a new AU buffer for the stream 1 (Step S11). To this end, as illustrated in FIGS. 12 and 25, the host 1 transmits the new AU write command for the stream 1 to the memory card 2. When receiving this new AU write command, the memory card 2 performs the fixing processing to the current AU buffer for the stream 1 (AU buffer 3) to prepare the new AU buffer for the stream 1 (AU buffer 4). Further, the register write controller 51 (FIG. 6) clears the address stored in the AU address register for stream 1 and its valid flag.

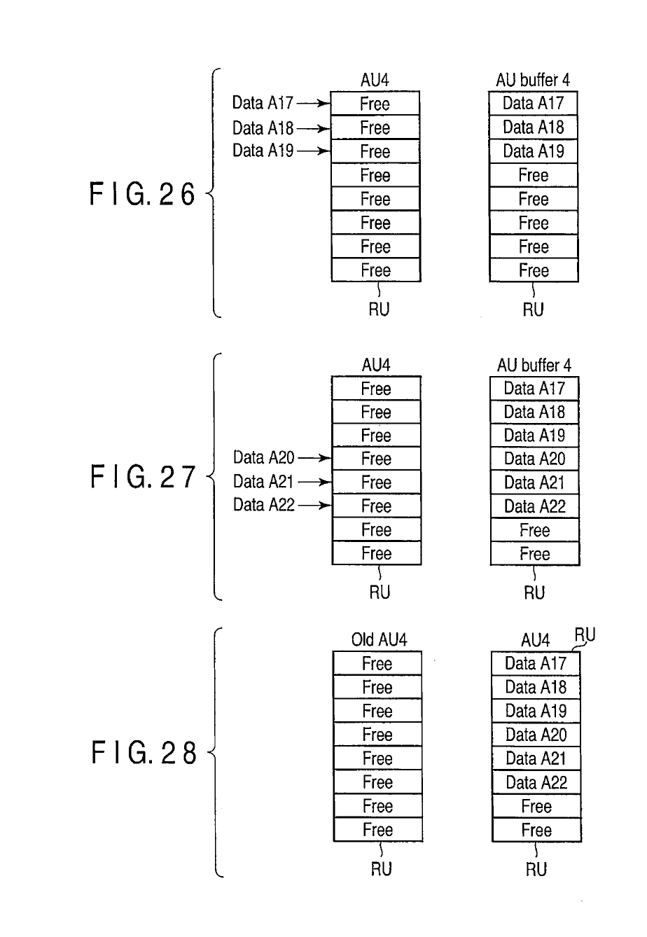

As illustrated in FIGS. 12 and 26, the host 1 requests to write the data items A17 to A19 for the stream 1 in the AU 4. To this end, the host 1 transmits the data write command and the data items A17 to A19 to the memory card 2. From the new AU write command preceding the data write command or the comparison by the comparison address unit 46, the memory card 2 recognizes that the data items A17 to A19 are for stream 1. Therefore, the memory card 2 writes the data items A17 to A19 in the first RU of the unwritten lowest address and following second and third RUs of the AU buffer 4, respectively.

As illustrated in FIG. 12, the host 1 requests to update the FAT data (Step S12). To this end, the host 1 transmits the write command (Update FAT) and FAT data for the FAT update to the memory card 2 (Step S12). As is well known by those skilled in the art, the FAT update is performed in particular timing during data writing, and the FAT update is for updating the latest FAT information for the data which has been written before the FAT update. The memory card 2 supports the FAT update in the sequential write mode, and is configured to be able to maintain the sequential write irrespective of the FAT update. For example, the memory card 2 sequentially writes the FAT data items in the RUs from the RU of the lowest address to the RU of the higher address in the AU buffer dedicated for the management data including the FAT. Note that the address in the FAT write command is not stored in the address registers 52 and 53. Accordingly, usually the address in such a write command should not match with any one of the addresses in the address registers 52 and 53. If the matching occurs, the memory card 2 transmits the error signal to the host 1.

As illustrated in FIG. 12, the host 1 requests to write at least part of the CI data for the stream 2 in the AU buffer for CI of the memory card 2 (Step S13). To this end, the host 1 transmits the CI update command, CI write command, and CI data for the stream 2 to the memory card 2.

As illustrated in FIGS. 12 and 27, the host 1 requests to write data items A20 to A22 for the stream 1 in the AU 4. To this end, the host 1 transmits the data write command and the data items A20 to A22 to the memory card 2. As described above with reference to FIG. 6, the address comparison unit 46 compares the AU addresses of the write addresses to recognize that the data items A20 to A22 are for stream 1. Therefore, the memory card 2 writes the data items A20 to A22 in the fourth RU of the unwritten lowest address and following fifth and sixth RUs of the AU buffer 4.

Assume that the data A22 is the final data for the stream 1, then the host 1 transmits the write end command for the stream 1 to the memory card 2 as illustrated in FIGS. 12 and 28 (Step S14). In response to this write end command, the memory card 2 performs the fixing processing to the current AU buffer 4 for the stream 1. As a result, the logical-physical table is updated to indicate that the AU buffer 4 now corresponds to the logical AU 4.

The memory card 2 transitions to the random write mode after receiving the write end command for the final stream. After the transition to the random write mode, the host 1 transmits the CI write command and CI data for the stream 1 to the memory card 2 as illustrated in FIG. 12. No restriction of the write time in the sequential write mode is applied to the memory card 2 because the memory card 2 is now in the random write mode. Therefore, when receiving the CI write command and the CI data, the memory card 2 completes the write of the CI for the stream 1. This CI write command is issued in the random write mode, and therefore does not need to follow the sequential write control command.

It is not necessary to issue the write end command in order to transition the memory card 2 to the random write mode after the write of the data for only stream. That is, the memory card 2 recognizes the end of the sequential write command when receiving the write command to request the random write such as the CI write command without the sequential write control command. The memory card 2 performs the fixing processing to the AU buffer similarly to the reception of the write end command. However, this case differs from the reception of the write end command in that the data in the RU that is not written is copied so as to be maintained. When the random write mode is designated without the write end command, the data in the address register 52 and its flag for the stream whose recording is not completed may not be cleared. In such cases, the memory card 2 clears the data in the address 52 and its flag when receiving the write end command for the corresponding stream.

As illustrated in FIG. 12, the host 1 transmits the CI write command and CI data for the stream 2 to the memory card 2. The memory card 2 completes the write of the CI for the stream 2 when receiving the command and the data.

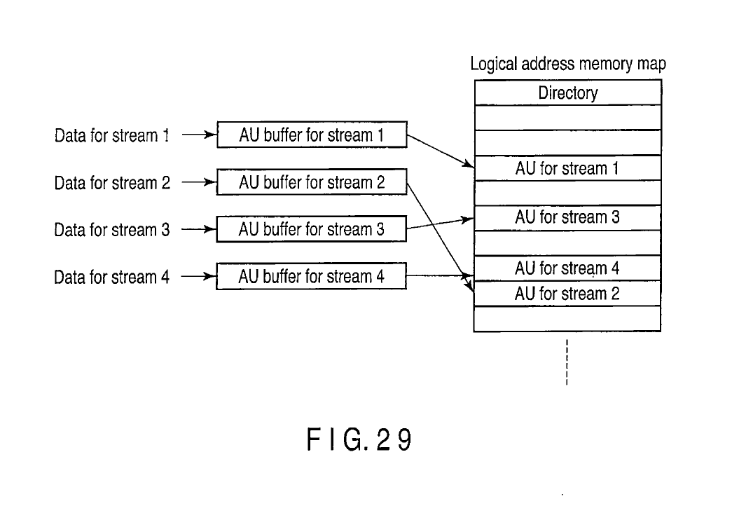

The description of FIGS. 12 to 28 deals with the example in which the two streams are recorded. However, the recording of three or four streams is realized by the principle similar to that of the two streams. When the four streams are concurrently written, four AU buffers are provided as illustrated in FIG. 29.

Operations of the host 1 and memory card 2 under conditions that are not described yet will be described below.

The memory card 2 can be configured to transmit the error signal to the host 1 when receiving the write command that corresponds to the random write and assigns the write address while two or more streams that are being written exist. This may result from the request formed by illegal control of the host 1 because the recording of the plurality of streams should complete with the end command. The memory card 2 transitions to the random write mode when the host 1 requests the wrong (illegal) control to the memory card 2 that is in the sequential write mode. Examples of such illegal control include a request for the sequential write and a request for the write other than the write of the integral multiple of the RU. Note that the read command has no influence on the write sequence.

When the write address indicates a root directory area, the write address is not stored in the address registers 52 and 53. Therefore, as a result of the comparison performed by the address comparison unit 46, the signal indicating that the matching occurs between the address comparators 54 and 55 is usually not output. Accordingly, the write data for the root directory area is written in not the AU buffer for stream recording but another buffer (for example, a buffer dedicated to a root directory).

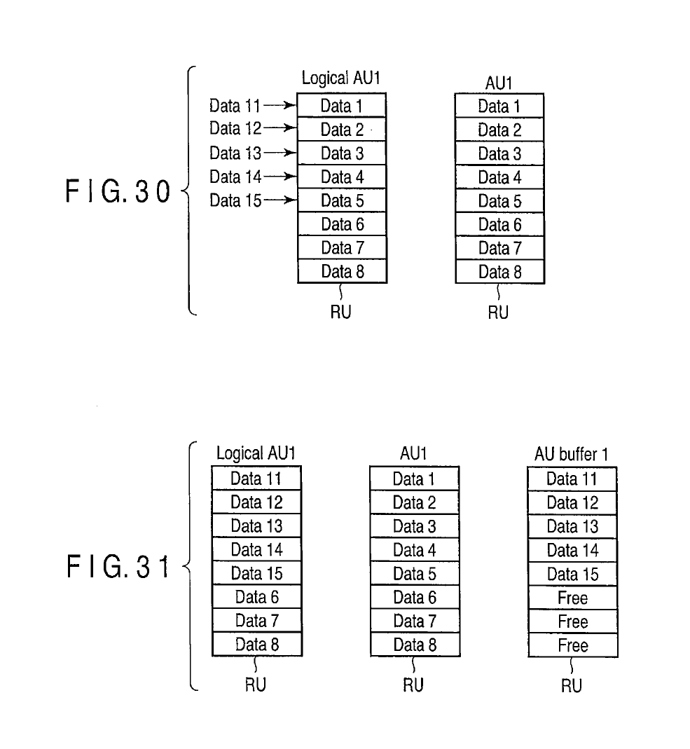

The data read will be described with reference to FIGS. 30 to 32. FIGS. 30 to 32 sequentially illustrates one state of the memory card 2 and host 1 during the data read.

The data read from the AU after the fixing processing is similar to the conventional memory card because the user (host 1) can access the fixing-processed AU. On the other hand, the read of the recorded data for a stream may be requested while the data for this stream is being recorded in the memory card 2. Even in such cases, the memory card 2 is configured to be able to also read the data from the AU before the fixing processing.

As illustrated in FIG. 30, the data items 1 to 8 allocated to the logical addresses belonging to the logical address group (logical AU) AU 1 are stored in the first to eighth RUs of the AU (physical AU) 1 of a memory 31, respectively. At this point, assume that the host 1 requests the memory card 2 to write stream data items 11 to 15, to which the logical addresses corresponding to the first to fifth RUs of the logical AU 1 are allocated. As a result, as illustrated in FIG. 31, the data items 11 to 15 are sequentially written from the RU 1 of the AU buffer 1 for this stream (stream 1 for example). At this point, the fixing processing of the physical AU 1 has not completed. If the host 1 requests to read the first to fifth RUs of the logical AU 1 to the memory card 2, the memory card 2 reads the data items 11 to 15 corresponding to these logical addresses (corresponding to the first to fifth RUs of the logical AU 1) from the AU buffer 1. Because the fixing processing has not been performed, the logical addresses corresponding to the first to fifth RUs of the logical AU 1 are allocated to the data items 1 to 5 of the AU 1, but the memory card 2 does not read the data items 1 to 5. On the other hand, if the host 1 requests to read the sixth to eighth RUs of the logical AU 1 to the memory card 2, the memory card 2 reads the data items 6 to 8 corresponding to the logical addresses of the sixth to eighth RUs of the logical AU 1.

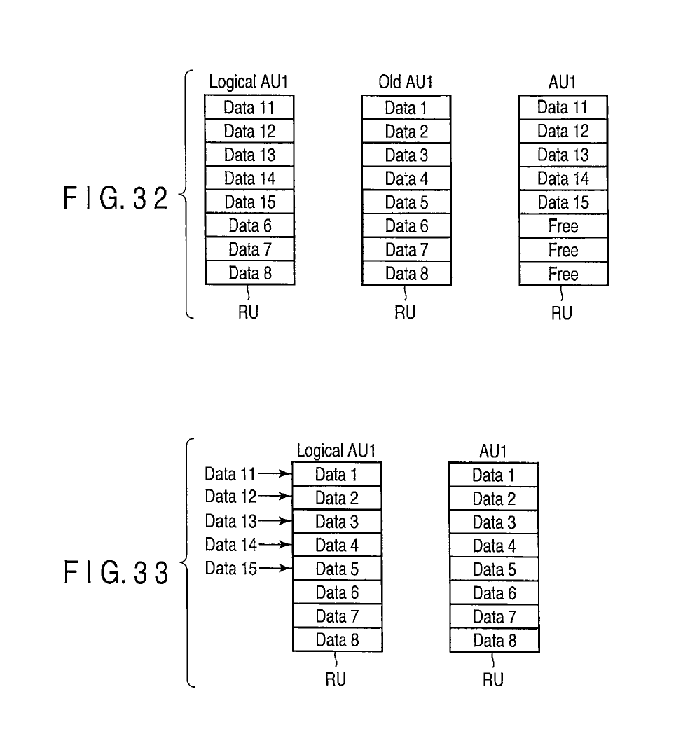

The fixing processing is performed similarly to the above description, and the memory card 2 updates the logical-physical table to indicate that the AU buffer 1 now corresponds to the logical AU 1 as illustrated in FIG. 32. Then the old physical AU 1 is erased at certain timing. The AU data can be read before the fixing processing through the above-described control.

When some sort of error occurs before the fixing processing, the AU buffer 1 becomes invalid. Therefore the data in the AU buffer 1 cannot be read. However, the correlation of the logical AU 1 and the physical AU 1 is still valid, and therefore the state before the write start (as illustrated in FIG. 30) can be restored.

As described above, the host and memory card of the first embodiment are configured to be able to recognize the sequential write command including the information specifying one of the plurality of streams, and the start or end of the recording can be specified for each stream. The memory card transitions to the sequential write mode when receiving the start command. In the sequential write mode, the write data items are sequentially written in the AU buffer comprising unwritten RUs in the order of the logical address of the write data. The write data items are arrayed in the order of the logical address in each stream of the corresponding AU buffer because the AU buffer is exclusively provided for each stream. Thus, the memory card can specify the stream of the write data to sequentially write the data in the AU buffer dedicated to each stream, so that the host and memory card of the first embodiment can concurrently record the plurality of streams.

### Second Embodiment

In the first embodiment, the AU buffer is prepared in the sequential write mode. On the other hand, in a second embodiment, the sequential write is performed without the AU buffer.

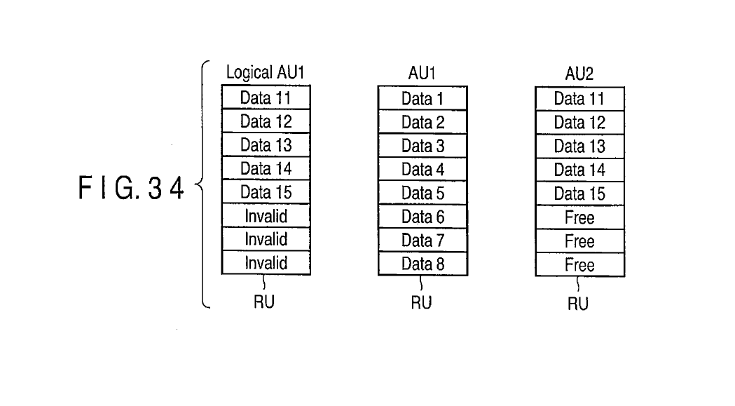

FIGS. 33 and 34 sequentially illustrate one state of a memory card 2 and a host 1 of the second embodiment during the data read.

As illustrated in FIG. 33, the data items 1 to 8 allocated with the logical addresses belonging to a logical AU 1 are stored in first to eighth RUs of a physical AU 1 of a memory 31, respectively. In such a state, the host 1 requests to write the stream data items 11 to 15 allocated with the logical addresses corresponding to the first to fifth RUs of the logical AU 1. In order to realize the request, the host 1 issues the new AU write command to the memory card 2.

When receiving the new AU write command, the memory card 2 prepares a new erased AU (AU 2, for example) as illustrated in FIG. 34. The memory card 2 also updates the logical-physical table to indicate that the AU 2 now corresponds to the logical AU 1. The data items 11 to 15 are written in the AU 2. Because the update of the logical-physical table is already ended, the memory card 2 reads the data items 11 to 15 from the AU 2 in response to a request to read the data items 11 to 15 from the host 1. The memory card 2 reads indefinite data in response to a request to read the data items allocated with the logical addresses corresponding to the remaining sixth to eighth RUs of the logical AU 1. Data representing nothing or data having a specific fixed value may be read out instead of the indefinite data.

In the second embodiment which does not use the dedicated buffer, it is possible to, in response to the data write request, to erase the currently corresponding AU (AU 1 in this example) to write the data in this erased AU. However, the NAND flash memory is usually configured to average the number of write times to each AU (referred to as ware leveling). Therefore, as described above, the new AU (AU 2 in this example) is prepared. Note that the data write without the internal buffer cannot restore the state before the write start (as illustrated in FIG. 33) if an error occurs while the data is being written in the replaced AU (AU 2).

The second embodiment is identical to the first embodiment except the above-described features.

As described above, similarly to the first embodiment, the host and the memory card of the second embodiment are configured to be able to recognize the sequential write command including the information specifying one of the plurality of streams, and the start or end of the recording can be specified for each stream using such configuration. Therefore the same advantages as the first embodiment are obtained.

### Third Embodiment

In a third embodiment, the sequential write mode includes a single stream mode and a multi-stream mode. Additionally, although the host 1 must issue the write command after the sequential write control command in the first embodiment, the restriction is relaxed in the third embodiment.

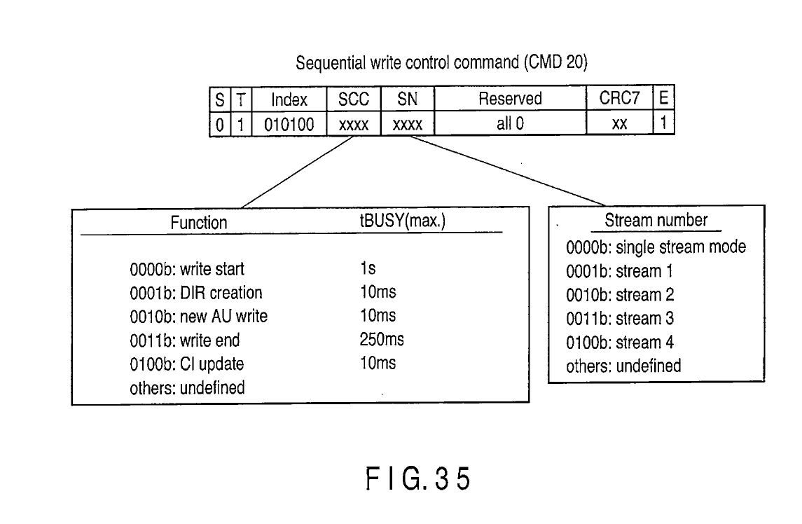

FIG. 35 schematically illustrates a sequential write control command of the third embodiment. In the third embodiment, SD interfaces 15 and 41 are configured to be able to recognize the command illustrated in FIG. 35. The sequential write command (CMD 20) of the third embodiment differs from that of the first embodiment only in types of the argument in the stream number portion SN. As illustrated in FIG. 35, similarly to the first embodiment, the argument that specifies for which one of streams 1 to 4 the sequential write control command is directed is defined in the stream number portion. Additionally, an argument that instructs a transition to the single stream mode is defined in the stream number portion. For example, the single stream mode is designated when the argument is “0000b (binary representation)”, the multi-stream mode is designated and the stream number is specified when the argument is more than “0000b”.

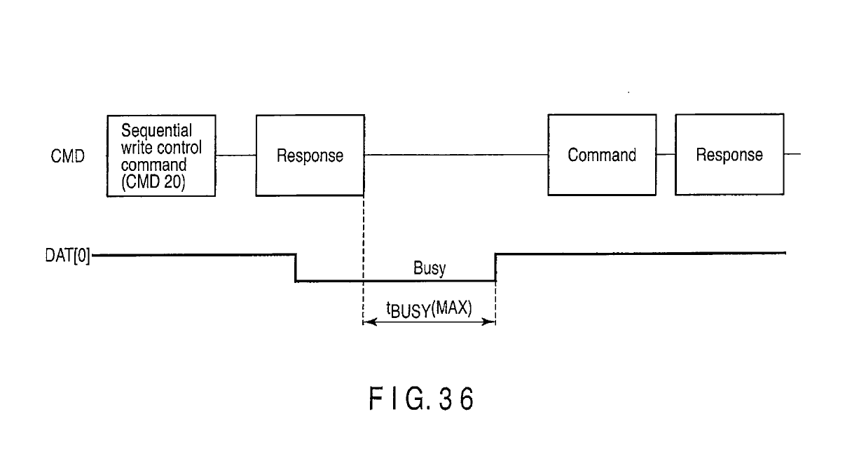

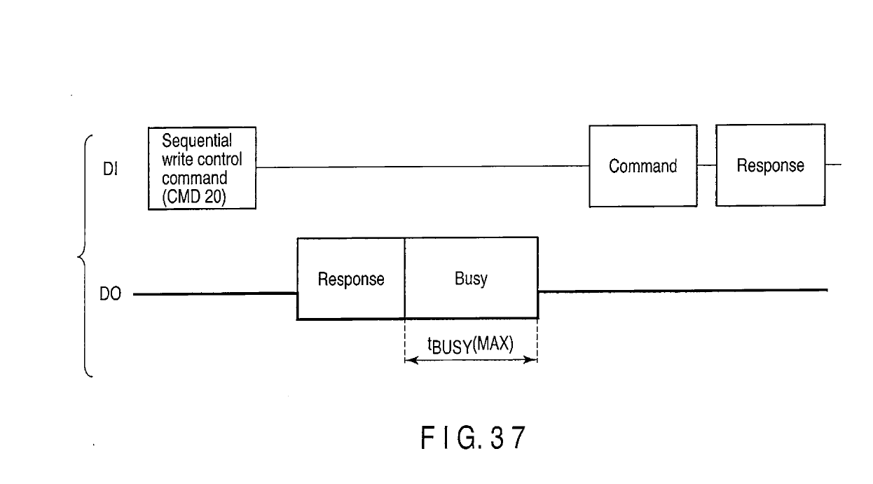

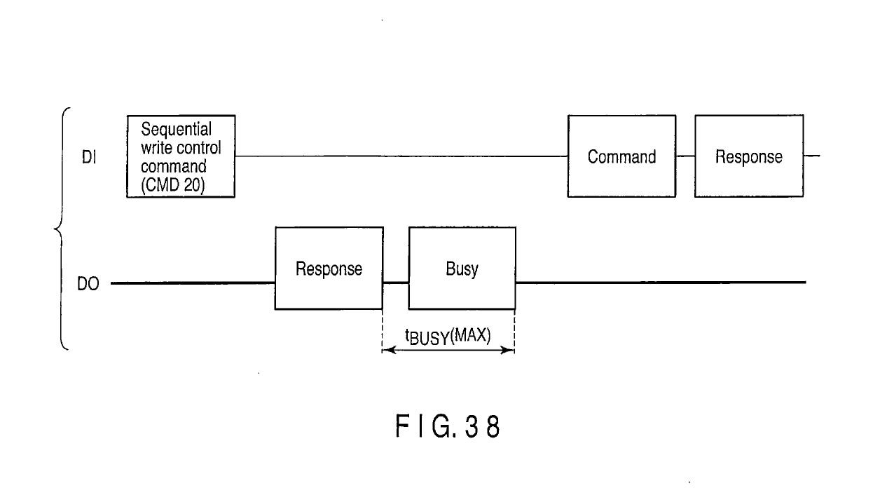

FIG. 36 illustrates a sequential write control command and a signal that is transmitted and received subsequent thereto between a host and a memory card. As illustrated in FIG. 36, when a host 1 transmits the sequential write control command on the command line, a memory card 2 transmits a response on the command line. When the sequential write control command is received by a memory card that does not recognize the command, it does not transmit the response. The memory card 2 transmits the busy signal to the host 1 on the data line as well as the response. The time t_{busy}(max) for which the memory card can remain in a busy state is similar to that of the first embodiment, and is predetermined according to a type of a function of the sequential write control command. FIGS. 37 and 38 illustrate the case in which the host 1 and the memory card 2 are connected by a unidirectional signal line. A signal line DI transmits a signal from the host 1 to the memory card 2, and a signal line DO transmits a signal from the memory card 2 to the host 1. FIGS. 37 and 38 correspond to SPI and UHS-II, respectively. In FIG. 37, a busy period is indicated by a level of the signal. For example, the busy is indicated by a low level immediately after the response. In FIG. 38, a packet indicating the busy is transmitted to the host. The host 1 recognizes the busy time by observing the busy packet. Other features of FIGS. 37 and 38 are identical to those of FIG. 36. As described, the command may be transmitted through a line other than the command line.

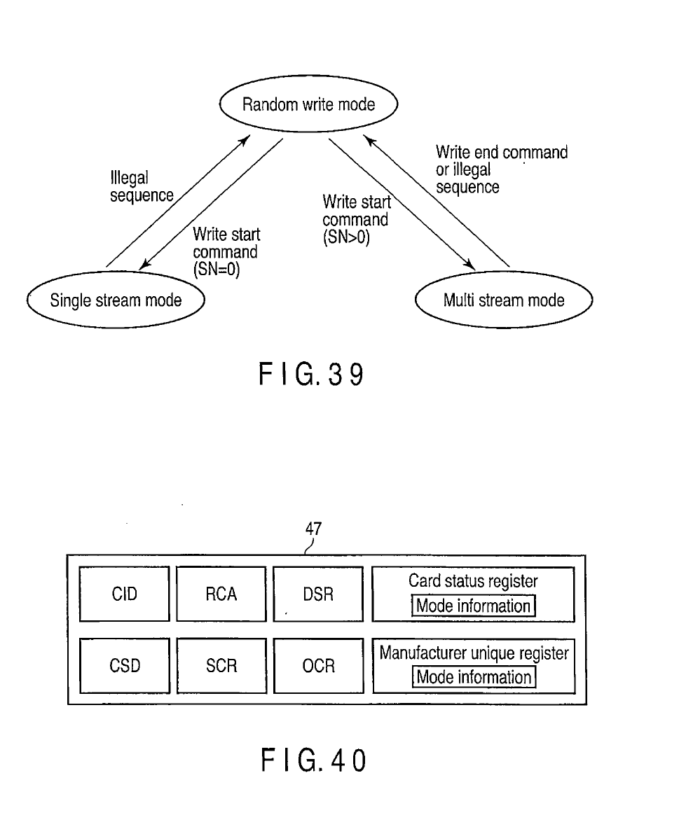

FIG. 39 illustrates a mode-state transition of the memory card of the third embodiment. As illustrated in FIG. 39, the memory card 2 can be operated in the random-write mode, the single stream mode, or the multi-stream mode. For example, the single stream mode corresponds to one that is described in Jpn. Pat. Appln. KOKAI No. 2010-140268. That is, when transitioning to the single stream mode, the memory card 2 prepares the AU buffer comprising only the unwritten RUs, writes the write data items in the RUs of the AU buffer in the order of the logical addresses of the write data items, and then performs the fixing processing at predetermined timing. Alternatively, similarly to the second embodiment, the logical-physical table may be reflected to indicate that the old AU is replaced before the fixing processing of the new erased AU without the use of the AU buffer, followed by writing in the new replaced AU. In the single stream mode, the write start command in the sequential write control command acts as a command for preparing multiple streams data recording, and the subsequent write command is recognized as a command requesting the sequential write. The CI update command is used to write the CI data that is different from the data during the sequential write, and the data of the sequential write is distinguished from the CI data. That is, even in the single stream mode, the CI update command and the CI write command are successively issued when the buffer 22 for CI is filled.

The multi-stream mode corresponds substantially to the sequential write mode of the first embodiment. However, the multi-stream mode differs from the sequential write mode of the first embodiment in the following point. In the third embodiment, the write start command and the write end command do not need to be followed by the write command in the sequential write control command. For example, the write start command and the write end command may be followed by processing of creating the directory or the file information. Such relaxation of the restriction differentiates the multi-stream mode from the sequential write mode of the first embodiment. In the third embodiment, the write start command issued in writing the data for the first stream acts only as the preparation command of the multiple streams data recording. That is, the write start command specifies the stream number, and therefore it instructs the transition to the multi-stream mode. The operation in the multi-stream mode is described later in detail.

The memory card 2 in the random access mode transitions to the single stream mode when receiving the sequential write control command that instructs the transition to the single stream mode (SN=0). The memory card 2 in the single stream mode transitions to the random access mode when receiving commands issued along a sequence requesting non-sequential-write control. Such a sequence includes a request for the write of inconsecutive logical addresses. The data stored in the not-to-be-written portion is retained during the transition from the single stream mode to the random write mode.

The memory card 2 in the random access mode transitions to the multi-stream mode when receiving the sequential write control command that instructs the transition to the multi-stream mode (SN>0). The memory card 2 in the multi-stream mode transitions to the random write mode when receiving the write end command for the final stream, or the write command interpreted to request the random write or the commands along the sequence requesting the wrong (illegal) control as described in the first embodiment.

In the transition from the multi-stream mode to the random write mode, only the necessary data is copied for areas to which no writing is instructed in the AU created in response to the new AU write command. The necessary data copy depends on implementation of the memory card. For example, if the AU is segmented to be managed, updating data in a segment of a logical AU may require a copy of data in the remaining segments of the logical AU.

The register 47 retains information indicating which mode the memory card 2 is in. The memory card 2 updates the mode information of the register 47 every time the mode transitions. As illustrated in FIG. 40, the mode information is also retained in the card status register or a manufacturer-unique register that is provided for a unique application by a manufacturer of the memory card. For example, the mode information is expressed by two bits, and 00, 01, and 11 mean the random mode, the single stream mode, and the multi-stream mode, respectively. For example, the mode information is treated as the status information, and the host 1 reads the mode information from the memory card 2 using the existing command used to read the status information. Unless the host 1 issues the commands in the normal sequence, the memory card 2 transitions to the random mode. Therefore, the mode information can be used to confirm whether the host 1 wrongly performs the control during debug of the host 1.

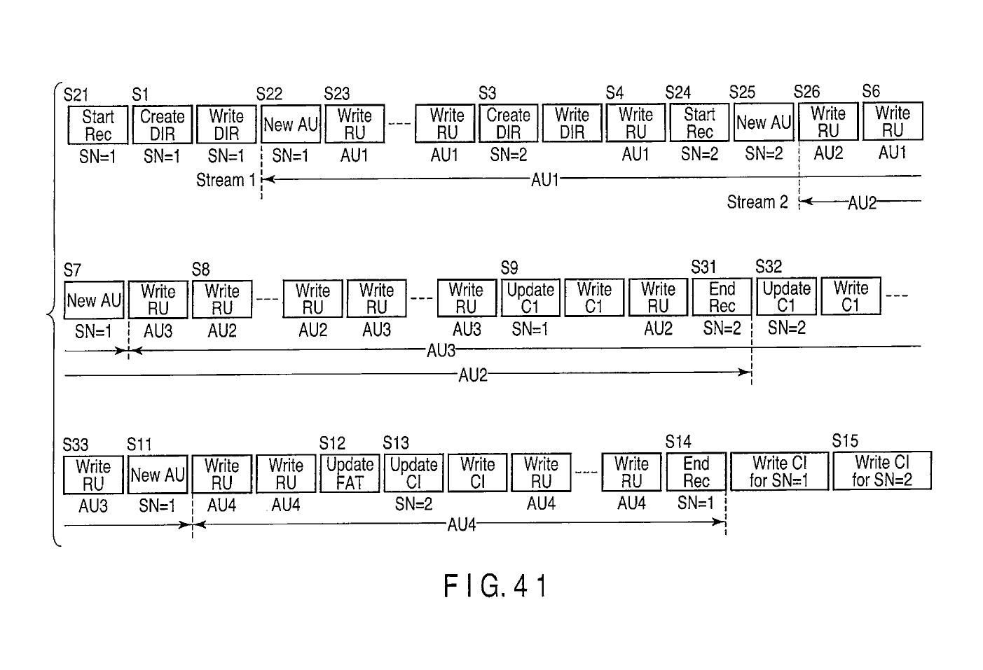

The operation in the multi-stream mode will be described below. FIG. 41 illustrates the command transmitted from the host 1 to the memory card 2 in time series. As illustrated in FIG. 13, the host 1 requests to write the data for the initial stream (stream 1). To this end, as illustrated in FIG. 41, the host 1 issues the write start command (Step S21). The write start command has the argument indicating the stream 1, and therefore instructs the memory card 2 to transition to the multi-stream mode.

Then as illustrated in FIG. 41, the host 1 creates the directory information for the stream 1. To this end, the host 1 performs Step S1 of the first embodiment. That is, the host 1 sequentially transmits the DIR create command, DIR write command, and DIR data for the stream 1 to the memory card 2. The memory card 2 writes the DIR data for the stream 1 in the AU of the instructed address or the AU buffer.

As illustrated in FIG. 41, the host 1 requests to write the data items A1 to A6 for the stream 1 in the AU 1. To this end, the host 1 issues the new AU write command (Step S22). The operation performed by the memory in response to the new AU write command card 2 is similar to that of the first embodiment. The new AU write command designates the stream 1. Accordingly, As illustrated in FIG. 14 and similarly to Step S7, the memory card 2 secures the AU buffer for the stream 1 (AU buffer 1) when receiving the new AU write command, and the register write controller 51 (FIG. 6) clears the AU address stored in the AU address register for stream-1 52a and its flag. In the third embodiment, after the write start command for a stream is issued, the new AU write command for the stream is issued before the initial write command of the data for the stream is issued.

Then the host 1 transmits the data write command and the data items A1 to A6 for the stream 1 to the memory card 2 (Step S23). Step S23 is identical to the processing from the write start command in Step 2 of the first embodiment. That is, from the preceding new AU write command, the memory card 2 recognizes that the data write command is for the data of the stream 1. The register write controller 46 retains the AU address of the write address. Then, as illustrated in FIG. 15, the memory card 2 writes the data items A1 to A6 in the first to sixth RUs of the AU buffer 1.

As illustrated in FIGS. 16 and 41, the host 1 requests to write the data B1 for the stream 2 in the AU 2 during the write of the stream 1. In order to prepare the write of the data B1, the host 1 performs Step S3 of the first embodiment to create and write the DIR for the stream 2. Then, as illustrated in FIG. 17, the host 1 performs Step S4 to write the data A7 in the AU buffer 1.

As illustrated in FIGS. 17 and 41, the host 1 continues the write of the data for the stream 2. To this end, the host 1 issues the write start command for the stream 2 similarly to Step S5 (Step S24). Then the host 1 issues the initial write command to write the data for the new stream (stream 2) after issuing the new AU write command specifying the stream 2 (Step S25). The memory card 2 secures the AU buffer for the stream 2 (AU buffer 2) when receiving the new AU write command, and the register write controller 51 (FIG. 6) clears the AU address stored in the AU address register for stream-2 52b and its flag.

Then the host 1 transmits the data write command and the data B1 for the stream 2 to the memory card 2 (Step S26). Step S26 is identical to the processing in the second half of Step S5 of the first embodiment. That is, from the preceding new AU write command, the memory card 2 recognizes that the data write command is for the data of the stream 2. The register write controller 46 retains the AU address of the write address. Then the memory card 2 writes the data B1 in the first RU of the AU buffer 2. The following operations are identical to those in Steps S6 to S9 of the first embodiment.

In order to end the write of the data for the stream 2, the host 1 transmits the write end command for the stream 2 to the memory card 2 as illustrated in FIG. 41 (Step S31). The processing identical to the processing of issuing the write end command in Step S10 of the first embodiment is performed in Step S31. That is, the fixing processing, and clearance of the AU address of the address register and its flag are performed.

After the write end command, the host 1 requests to update the CI data for the stream (stream 2) whose data write is ended. As described above, the write command is not necessary to follow immediately the write end command. Therefore, the host 1 issues the CI update command for the stream 2 to the memory card 2 before issuing the CI write command for the stream 2 (Step S32). Then the host 1 transmits the CI write command and the CI data to the memory card 2. The memory card 2 recognizes that the write command is for writing the CI data from the preceding CI update command and writes the CI data in the buffer for CI.

Similarly to the final part of Step S10, the data A16 for the stream 1 is written in the AU buffer 3 (Step S33). The following operations are identical to those in Steps S11 to S15 of the first embodiment.

In the third embodiment, features other than those described above are identical to those of the first embodiment. The second embodiment can also be applied to the third embodiment. That is, the data is written without the internal buffer.

As described above, similarly to the first embodiment, the host and memory device of the third embodiment are configured to be able to recognize the sequential write command including the information specifying one of the plurality of streams, and the start or end of the recording can be specified for each stream. Therefore, the same advantages as the first embodiment are obtained.

Additionally, in the third embodiment, the write start command and the write end command do not need to be followed by the write command. Therefore, the management data such as the CI update and the DTR update can be written and updated in any selected timing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a nonvolatile semiconductor memory which comprises storage areas; and
a controller which receives write data items, has a random write mode and a sequential write mode, and transitions to the sequential write mode when receiving a start command, the controller in the sequential write mode:
recognizing a control command,
identifying one of data streams which is partially formed by one write data item through the control command or a logical address,
preparing free unit areas comprising a predetermined number of the storage areas for respective data streams,
writing write data items in successive storage areas in a corresponding unit area in an order identical to addresses of the write data items,
performing, when receiving an end command, end processing on a unit area for one corresponding data stream, and
transitioning to the random write mode when completing the end processing to all of the data streams or detecting a random write request.

2. The device according to claim 1, wherein
the control command includes information specifying one data stream which is partially formed by data item to be written by a write command following the control command and information specifying an instruction assumed by the control command, and
the control command acts as one of the start command for one data stream specified by the control command, the end command for a specified data stream, a command instructing to prepare a new unit area for data recording, and a command for identifying writing of data other than data streams.

3. The device according to claim 1, wherein
the controller comprises an address comparison unit,
the address comparison unit comprises:
registers dedicated to respective data streams, and store a destination address of one write data item specified by the write command following the control command; and
comparators which correspond to respective registers, and output a signal when a destination address specified by a received write command matches with the destination address stored in a corresponding register, and
the controller correlates the received write command to one unit area for one data stream corresponding to one comparator which outputs the signal.

4. The device according to claim 1, wherein
the unit area comprises a buffer temporarily prepared in the memory,
the buffer comprises a predetermined number of free storage areas, and
the unit area is inaccessible from an outside of the device before the end processing on the unit area completes.

5. The device according to claim 1, wherein
the unit area comprises the predetermined number of free storage areas and is accessible from an outside of the device.

6. The device according to claim 1, wherein
the control command includes information specifying one data stream directed by the control command or one data stream which is partially formed by data item to be written by a write command following the control command and information specifying an instruction assumed by the control command, and
the control command acts as one of the start command for one data stream specified by the control command, the end command for a specified data stream, a command instructing to prepare a new unit area for data recording, and a command for identifying writing of data other than data streams.

7. The device according to claim 6, wherein
the device further has a second sequential mode in which the write data items for one data stream are successively written in successive storage areas of the unit area in an order identical to logical addresses of the write data items, and
the start command includes information instructing a transition to the sequential write mode and specifying one data stream directed by the start command or information instructing a transition to the second sequential write mode.

8. The device according to claim 6, wherein
the controller comprises an address comparison unit,
the address comparison unit comprises:
registers dedicated to respective data streams, and store a destination address of one write data item specified by the write command following the control command; and
comparators which correspond to respective registers, and output a signal when a destination address specified by a received write command matches with the destination address stored in a corresponding register, and
the controller correlates the received write command to one unit area for one data stream corresponding to one comparator which outputs the signal.

9. The device according to claim 6, wherein
the unit area comprises a buffer temporarily prepared in the memory,
the buffer comprises a predetermined number of free storage areas, and
the unit area is inaccessible from an outside of the device before the end processing on the unit area completes.

10. The device according to claim 6, wherein
the unit area comprises the predetermined number of free storage areas and is accessible from an outside of the device.

11. A host device configured to write data in a memory device, the memory device comprising a nonvolatile semiconductor memory which comprises storage areas and a controller which controls the memory, the host device comprising:
application software which divides data to be written in the memory to prepare write data items of a predetermined size; and
an interface which issues a start command and a control command, the start command instructing the memory device to transitions to a sequential write mode in which the write data items are written such that an order of addresses of the storage areas is identical to an order of logical addresses of the write data items written in the storage areas, the control command being issued before a write command to instruct writing of one write data item and specifying one of data streams which is partially formed by the data item to be written by the write command.

12. The device according to claim 11, further comprising a flow controller which receives performance information indicating a lowest write rate guaranteed by the memory device and comprises a rate determining unit which determines the number of data streams which can be written in the memory device without interference of each stream write performance and bit rates for respective data streams using the performance information.

13. The device according to claim 12, wherein
the flow controller comprises data buffers dedicated to respective data streams to retain write data items partially constituting respective data streams, and
the flow controller is configured to transmit the write data items in the data buffers in a time-sharing principle in order to realize the bit rates determined for respective data streams within a bit rate supported by the memory device.

14. The device according to claim 11, wherein the interface
is further configured to issue an end command instructing to perform end processing on a unit area for one corresponding data stream, and
causes the memory device to transition to a random write mode by issuing the end command for all of the data streams or requesting random write.

15. The device according to claim 14, wherein
the control command includes information specifying one data stream which is partially formed by data item to be written by a write command following the control command and information specifying an instruction assumed by the control command, and
the control command acts as one of the start command for one data stream specified by the control command, the end command for a specified data stream, a command instructing to prepare a new free unit area comprising a predetermined number of the storage areas, and a command for identifying writing of data other than data streams.

16. The device according to claim 14, wherein
the control command includes information specifying one data stream directed by the control command or one data stream which is partially formed by data item to be written by a write command following the control command and information specifying an instruction assumed by the control command, and
the control command acts as one of the start command for one data stream specified by the control command, the end command for a specified data stream, a command instructing to prepare a new free unit area comprising a predetermined number of the storage areas, and a command for identifying writing of data other than data streams.

17. The device according to claim 16, wherein
the interface is configured to issue a command instructing to prepare a new unit area before issuing a initial write command to write the write data items partially constituting one new data stream in the memory device in the sequential write mode.

18. The device according to claim 16, wherein
the start command includes information instructing a transition to the sequential write mode and specifying one data stream directed by the start command or information instructing a transition to the second sequential write mode in which the write data items for one data stream are successively written in successive storage areas of the unit area in an order identical to logical addresses of the write data items.
